(19) United States
(12) Patent Application Publication
(10) Pub. No.: US 2026/0276458 A1
(43) Pub. Date: Sep. 17, 2026

(54) LATTICE-STRUCTURED PRESSURE SENSOR AND A SYSTEM AND METHOD FOR USE AND CALIBRATION THEREOF

(71) Applicant: THE GOVERNING COUNCIL OF THE UNIVERSITY OF TORONTO, Toronto (CA)

(72) Inventors: Mohammadamin JAMSHIDI, Toronto (CA); Faezeh AZHARI, Toronto (CA)

(21) Appl. No.: 19/480,161

(22) PCT Filed: May 10, 2024
(86) PCT No.: PCT/CA2024/050634

§ 371 Date: Oct. 30, 2025

Related U.S. Application Data
(60) Provisional application No. 63/501,929, filed on May 12, 2023.

(51) Int. Cl. G01L 1/20; G01L 25/00

(52) U.S. Cl. CPC G01L 1/205; G01L 25/00

(57) ABSTRACT

There is provided a pressure sensor for converting applied pressure to electrical signals, a method for using the pressure sensor, and a method for calibrating the pressure sensor. The pressure sensor including: a non-conductive substrate; conductive material in the non-conductive substrate, the conductive material forming a lattice structure; and a plurality of electrodes connected to the conductive material at respective locations of a boundary of the lattice structure.

### TECHNICAL FIELD

The present disclosure relates generally to pressure sensors. More particularly, the present disclosure relates to a lattice-structured pressure sensor and a system and method for use and calibration thereof.

### BACKGROUND

Tactile sensing is key to meaningful interaction between machine and human. Interactions can take place through soft robotic skin, wearable sensors, and rehabilitation monitoring. A particular interface can consist of artificial spatially distributed skin-like sensors (or ‘soft sensing skins’) with high flexibility/stretchability and desired sensing properties. Arrays of solid-state sensors can be used to collect tactile information such as pressure from large areas. However, there are generally weak interactions, wiring complexities, and difficult data acquisition, amongst others.

Nonetheless, artificial skin-like sensors (or soft sensing skins) have garnered significant interest in human-machine interaction applications; such as touch recognition, soft robotic skins, gait recognition, rehabilitation, physiological signal monitoring, weight-in-motion systems, gait walkways, amongst many others. Pressure measurement is a key feature of such sensors. To efficiently measure soft body dynamics and external stimuli, sensors in a skin form factor should offer, for example, high flexibility, stretchability, sensitivity, and spatial resolution.

### SUMMARY

In an aspect, there is provided a pressure sensor for converting applied pressure to electrical signals, the pressure sensor comprising: a non-conductive substrate; conductive material in the non-conductive substrate, the conductive material forming a lattice structure; and a plurality of electrodes connected to the conductive material at respective locations of a boundary of the lattice structure.

In a particular case of the pressure sensor, the conductive material comprises a carbon black composite, a silicone composite, or carbon black, binder and/or rubber crumbs.

In another case of the pressure sensor, the conductive material further comprises steel fiber and/or cementitious binder.

In yet another case of the pressure sensor, the conductive material forms a plurality of channels that are connected to each other to form nodes on the sensing skin, the respective location of each of the electrodes is at a respective one of the nodes.

In yet another case of the pressure sensor, the pressure sensor further comprising a non-conductive substrate, wherein the conductive material is located inside the non-conductive substrate.

In yet another case of the pressure sensor, the non-conductive substrate comprises a silicone rubber.

In another aspect, there is provided a method of using a pressure sensor, the pressure sensor comprising a non-conductive substrate, a conductive material in the non-conductive substrate that forms a lattice structure, and a plurality of electrodes connected to the conductive material, the method comprising: selecting a pair of electrodes; iteratively performing: directing current to the selected pair of electrodes; receiving voltage measurements across non-selected electrodes; determining whether each pair of electrodes has been selected, and where each pair of electrodes has not been selected, selecting a previously not selected pair of electrodes and performing a further iteration, otherwise performing no further iterations; determining resistivity and/or conductivity at each node in the lattice structure using the voltage measurements; correlating the resistivity and/or conductivity value at each node to a pressure value using a calibrated transfer function; and outputting the pressure values;

In a particular case of the method of using the pressure sensor, determining the resistivity and/or conductivity at each node in the lattice structure comprises using an inverse Maxwell equation.

In another case of the method of using the pressure sensor, the inverse Maxwell equation is solved considering an inverse of a Jacobian matrix to determine conductivity or resistivity changes based on known differential voltage measurements across a boundary of the lattice structure.

In yet another case of the method of using the pressure sensor, temporal changes in conductivity or resistivity are determined by evaluating instant potential measurements and homogeneous baseline potential measurements at two different times and the difference is determined using the Jacobian matrix.

In yet another case of the method of using the pressure sensor, directing current to the selected pair of electrodes comprises injecting a constant current into the pair of electrodes.

In yet another case of the method of using the pressure sensor, directing current to the selected pair of electrodes comprises using a constant voltage source to inject current into the pair of electrodes.

In yet another case of the method of using the pressure sensor, the method further comprising using a voltage divider resistor to measure the current injected into the pair of electrodes.

In yet another case of the method of using the pressure sensor, the selected pair of electrodes are adjacent electrodes.

In yet another case of the method of using the pressure sensor, directing current to the selected pair of electrodes comprises using a direct-current source.

In yet another case of the method of using the pressure sensor, directing current to the selected pair of electrodes comprises using an alternating-current source, and wherein the resistivity and/or conductivity values comprise admittance and/or impedance values.

In another aspect, there is provided a method of calibrating a pressure sensor, the pressure sensor comprising a non-conductive substrate, a conductive material in the non-conductive substrate that forms a lattice structure, and a plurality of electrodes connected to the conductive material, the method comprising: iteratively performing for a predetermined number of iterations: applying a selected pressure to the sensor, the selected pressure having not previously been selected; selecting a pair of electrodes; iteratively performing while the selected pressure is applied to the pressure sensor: directing current to the selected pair of electrodes; receiving voltage measurements across non-selected electrodes; determining whether each pair of electrodes has been selected, and where each pair of electrodes has not been selected, selecting a previously not selected pair of electrodes and performing a further iteration, otherwise performing no further iterations; determining resistivity and/or conductivity at each node in the lattice structure using the voltage measurements; correlating the resistivity and/or conductivity value at each node to the known pressure value; determining a transfer function correlating change in resistivity and/or conductivity to pressure based on the relationship between the change in resistivity and/or conductivity and the applied pressure; and outputting the transfer function.

In a particular case of the method of calibrating the pressure sensor, determining the transfer function correlating change in resistivity and/or conductivity to pressure based on the relationship between the change in resistivity and/or conductivity and the applied pressure comprises using Tikhonov regularization and Gauss-Newton reconstruction to determine reconstructed changes in relative resistance at different pressure values and at different points over the lattice to derive the transfer function.

In another case of the method of calibrating the pressure sensor, the lattice structure is conceptually divided into a finite number of elements for Tikhonov's regularization and Gauss-Newton reconstruction.

In yet another case of the method of calibrating the pressure sensor, the method further comprising using a deep learning model to predict resistivity and/or conductivity during calibration.

These and other aspects are contemplated and described herein. It will be appreciated that the foregoing summary sets out representative aspects of systems and methods to assist skilled readers in understanding the following detailed description.

### BRIEF DESCRIPTION OF THE DRAWINGS

The features of the invention will become more apparent in the following detailed description in which reference is made to the appended drawings wherein:

FIG. 1 is a perspective view of an example planar implementation of a pressure sensor, in accordance with an embodiment;

FIG. 2 is a flow diagram of an example preparation of a composite mixture to fabricate the lattice structure of the pressure sensor of FIG. 1;

FIG. 3 is a diagram showing an example structure for the pressure sensor of FIG. 1;

FIG. 4 is a flow diagram showing an example of fabrication of the pressure sensor of

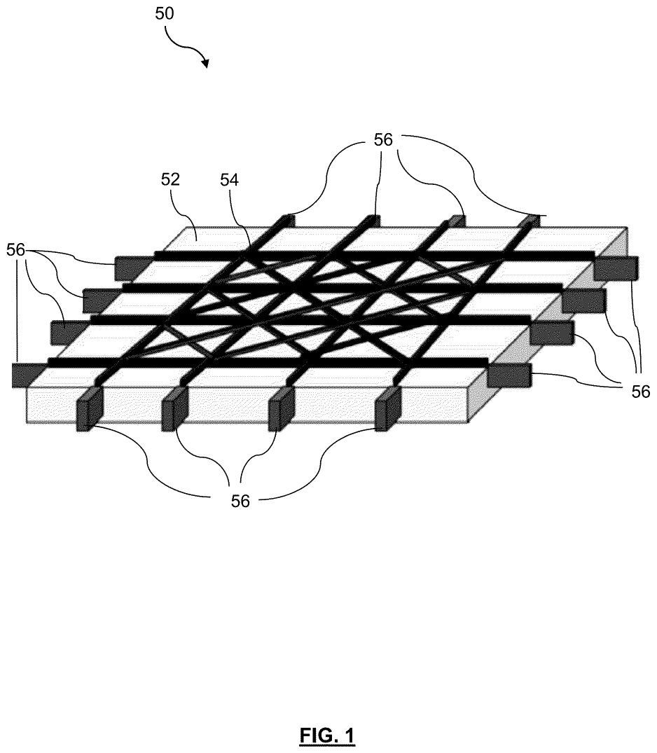

FIG. 1;

FIG. 5 is a chart illustrating stress-strain responses of silicone and a CB/silicone 24 composite;

FIG. 6 is a diagram showing a system for using a lattice-structed pressure sensor, in accordance with an embodiment;

FIG. 7 is a diagram showing a method for using the lattice-structured pressure sensor, in accordance with an embodiment;

FIG. 8 illustrates a diagram of an example implementation of the system of FIG. 6;

FIG. 9 illustrates a diagram of an example implementation of the method of FIG. 7;

FIG. 10 is a diagram showing a method for calibrating the lattice-structured pressure sensor, in accordance with an embodiment;

FIG. 11 shows an example approach for loading the sensor for the calibration of FIG. 10;

FIG. 12 shows a diagram showing pressure points applied to the sensor for an example calibration according to FIG. 10;

FIGS. 13A to 13E shows sensor response at the five locations on the sensor, P1 to P5, respectively, for the example calibration according to FIG. 10;

FIG. 14 is a chart showing a comparison of sensitivity values at the five distinct loading points on the sensor shown in FIG. 12;

FIG. 15 displays a two-dimensional transfer function derived by interpolating a transfer function obtained for the five distinct loading points shown in FIG. 12 for the example calibration according to FIG. 10;

FIG. 16 illustrates charts showing repeatability of measurements for the sensor of FIG. 1;

FIGS. 17A and 17B illustrate the sensor's response to an applied pressure of 40 kPa at the five distinct loading points shown in FIG. 12;

FIG. 18 illustrates responses to double and quadruple touch experiments performed on the sensor of FIG. 1;

FIG. 19 illustrates an example hardware implementation of the sensor of FIG. 1 and the system of FIG. 6, for various three-dimensional (3D) shaped applications;

FIG. 20A is a chart illustrating current paths and equipotential lines in an adjacent current injection of the sensor of FIG. 1;

FIG. 20B is a front view of an example 3D implementation of the pressure sensor of FIG. 1;

FIG. 20C is a diagram illustrating an interconnected lattice network based on equipotential paths;

FIG. 21 is a flowchart illustrating an example of generation of computer aided design (CAD) files for a mold for fabrication of the 3D implementation of the pressure sensor of FIG. 1;

FIG. 22 shows an example fabrication procedure for the 3D implementation of the pressure sensor of FIG. 1;

FIG. 23 shows an example implementation of the calibration of FIG. 10, and a resulting sensitivity distribution, for the 3D implementation of the pressure sensor of FIG. 1;

FIG. 24 illustrates the results of one point used in the calibration of FIG. 23 with C/Cₘₐₓ= 1/7;

FIG. 25 illustrates the results of another point used in the calibration of FIG. 23 with C/Cₘₐₓ= 3/7;

FIG. 26 illustrates the results of another point used in the calibration of FIG. 23 with C/Cₘₐₓ 5/7;

FIG. 27 illustrates a response at C/Cₘₐₓ= 1/7 on the 3D implementation of the pressure sensor of FIG. 1;

FIG. 28A shows a chart showing spatial resolution, and FIG. 28B shows a chart showing position error, for different arc ratios (C/Cₘₐₓ), and whether the measured point is located on an electrode (E) or not (NE);

FIG. 29A shows an example of testing of the 3D implementation of the pressure sensor of FIG. 1 for three different loading values (3, 5, and 7 Newton (N)) at three angles (60°, 90°, and) 120° applied at C/Cₘₐₓ=3.5/7;

FIG. 29B is a chart showing sensitivity results for the testing in FIG. 29B;

FIG. 30A illustrates results of testing the 3D implementation of the pressure sensor of FIG. 1 at two points spaced 3 cm apart proximate the middle of the sensor;

FIG. 30B illustrates results of testing the 3D implementation of the pressure sensor of FIG. 1 at two points spaced 5.5 cm apart with one point proximate the in middle of the sensor and the other point proximate the boundary of the sensor;

FIG. 30C illustrates results of testing the 3D implementation of the pressure sensor of FIG. 1 at three points, with two points spaced 2.5 cm apart proximate the middle of the sensor and another point proximate the boundary of the sensor; and

FIG. 30D illustrates results of testing the 3D implementation of the pressure sensor of FIG. 1 at three points, with each point spaced 5.25 cm apart from each other and proximate to the boundary of the sensor.

### DETAILED DESCRIPTION

Embodiments will now be described with reference to the figures. For simplicity and clarity of illustration, where considered appropriate, reference numerals may be repeated among the Figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description.

Any module, unit, component, server, computer, terminal, engine or device exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the device or accessible or connectable thereto. Further, unless the context clearly indicates otherwise, any processor or controller set out herein may be implemented as a singular processor or as a plurality of processors. The plurality of processors may be arrayed or distributed, and any processing function referred to herein may be carried out by one or by a plurality of processors, even though a single processor may be exemplified. Any method, application or module herein described may be implemented using computer readable/executable instructions that may be stored or otherwise held by such computer readable media and executed by the one or more processors.

The following relates generally to pressure sensors. More particularly, the present disclosure relates to a lattice-structured pressure sensor and a system and method for use and calibration thereof.

Spatially distributed sensing has become increasingly useful in wearable devices. In embodiments of the present disclosure, a sensor is provided for distributed pressure sensing; in some cases, the sensor can be flexible and skin-like. The sensor can be composed of a conductive lattice structure embedded in a sheet of substrate. In most cases, electrical impedance tomography (EIT) can be used to reconstruct electrical resistance over the sensing area, which can then be mapped into pressure distribution using piezoresistivity. EIT reduces complexity and eliminates the need for internal wiring. The lattice sensor offers substantially advantageous sensing attributes, including, in example experiments, a linear response range of 12-190 kPa (R²=0.99), sensitivity as high as 0.12 kPa⁻¹, spatial resolution of 1.4 mm, and high repeatability (~0.5% drop in maximum relative resistance over 300 cycles). The sensor of the present embodiments was able to detect both single-point and multi-point touch.

Various approaches for measuring pressure distribution can involve, for example, arrays of individual solid-state sensors embedded in a flexible polymeric skin. These sensors range from discrete arrays of transistors or piezoresistive semiconductors to sensors that use, for example, capacitive, magnetic, piezoelectric, optical, and other principles. Such sensors only offer discrete measurements, often have weak measurement interfaces, and suffer from wiring complications that decrease durability.

Sensors, in the form of distributed sensors (informally referred to herein as a ‘sensing skins’), made of conductive polymer composites, are generally popular due to their mechanical properties and stable response under strain/stress. Piezoresistive or piezocapacitive properties are commonly used in the sensing mechanism. For example, a modular capacitive sensing skin comprising a soft dielectric layer sandwiched between electrodes. Such approach provides good spatial resolution for pressure measurement but, owing to the large number of electrodes, suffers from stray capacitance, high noise sensitivity, and electronic measurement complexity. Piezoresistive sensing skins can be made up of a layer of piezoresistive polymer sandwiched between electrode grids. To address power consumption issues and low sensitivity, a grid structure for the piezoresistive polymer can be used. The grid sensing skin can provide higher sensitivity compared with a solid configuration, but the presence of electrodes on both sides made it thicker. In some cases, sinusoidal wiring made of carbon fiber can be used to eliminate bulky electrode connections between pressure sensors.

Pressure measurements, however, generally remain discrete in the above approaches. With an array of sensors covering the surface, such approaches only provide pressure measurements at those discrete locations where the sensors are placed, and would not generally allow for measurements in areas not covered by the sensor.

The inclusion of many piezoresistive and/or piezocapacitive sensing units and circuits generally lead to complicated and expensive fabrication processes. Electrical impedance tomography (EIT) reconstructs 2D or 3D resistance change distributions in a conductive media by measuring potentials at boundary electrodes; eliminating the need for arrays of discrete sensing components and internal wiring. Using EIT for measuring pressure distributions in a sensor offers advantages; such as conformability, design simplicity, and low assembly costs.

EIT can be used to measure stress and/or strain distributions on uniform sensing skins. In an example approach, a skin sensor can be fabricated by applying carbonic paint over a flexible substrate. However, maintaining a consistent paint thickness over a rubber substrate is difficult and may result in a non-uniform baseline resistivity distribution and a small sensitivity range. In another example approach, a two-layer EIT-based tactile sheet can be composed of a network of wave-like conductive yarns and an array of highly conductive small silver-coated fabric pieces. However, this approach has a coarse sensing network and is limited by the type of sewing machine and manufacturing procedure.

Local pressure induces small fractional resistance changes in distributed sensors, which can lead to inaccurate location detection by EIT. The distributed sensor of the present embodiments includes conductive paths arranged in a lattice pattern; resulting in higher sensitivity and spatial resolution than uniformly distributed sensors. Embodiments of the present disclosure incorporate a lattice pattern of conductive silicone within a silicone sheet. The lattice-arrangement of the distributed sensor provides substantially higher and more consistent sensitivity throughout the sensing area because the conductive channels carry a higher current density; leading to more pronounced changes in potential in response to applied pressure.

With a simple grid structure for a conductive material, if a current is injected into adjacent electrodes, when pressure is applied near shorter current paths (closer to the boundary), the potential changes are high but not in other areas (such as the center); resulting in low sensitivity. In contrast, the ability of the sensor of the present embodiments is able to cover large sensing areas, and 3D surfaces are particularly beneficial. The sensor of the present embodiments has a lattice structure with an enhanced sensitivity value and high spatial resolution, which eliminates internal wiring. Moreover, the sensor of the present embodiments can be fabricated into 3D geometries, as described herein.

FIG. 1 illustrates a lattice-structured pressure sensor 50, in accordance with an embodiment. The pressure sensor 50 includes a substrate 52, a conductive material 54 that is located in the substrate and forms an interconnected lattice structure, and electrodes 56 connected to the conductive material at various locations circumscribing a boundary of the lattice structure. In some cases, the substrate 52 can comprise an elastomeric material, for example, silicone; however, any substantially non-conductive material that is deformable enough to be sensitive to applied pressure can be used. The conductive material 54 has pressure sensing properties. The conductive material 54 can be any piezoresistive or piezocapacitive material. In some cases, the conductive material 54 can be a composite with a matrix that is polymeric, silicone-based, cementitious, or the like. Filler in the composite can be carbon black, rubber crumbs, steel fibers, nanotubes, nanofibers, graphene and graphene variations, steel fibers, or the like. In an advantageous example, the composite can comprise a combination of carbon black and silicone. Accordingly, any suitable composite materials can be used that provides a suitable resistivity and/or conductivity.

The pressure sensor 50 can be active (sensing and actuation) or passive (only sensing). For a passive sensor, the conductive material 54 can have piezoresistive, piezocapacitive, and/or impedance properties. While a preferred approach uses piezoresistive properties, it is understood that any suitable pressure sensor, or any combination thereof, can be used.

‘Finite element’, as used herein, denotes that determinations of resistance/conductivity/capacitance are determined for finite points (also called nodes) on the sensor 50, where these values of the nodes can be related using a transfer function on each element. In this way, a combination of the nodes and elements create a mesh, which can be much finer than the lattice structure of the conductive material 54.

In the context of the sensor 50, “lattice” generally refers to a structure of interlaced elements, such as a grid with additional intersecting elements. The sensor 50 of the present embodiments generally can have the following properties:
Connectivity: The conductive material 54 forms channels that should be connected to each other to create nodes on the sensing skin. Either directly or indirectly, the conductive channels can be connected to the boundary electrodes 56.
Regularity: The conductive material 54 can be arranged in a regular, repeating pattern that allows for reliable and consistent sensing across the entire sensing area.
Packability: The conductive material 54 is located inside a non-conductive substrate 52 to ensure high sensitivity and resolution.
Deformability: The conductive material 54 can be stretchable and deformable along with the substrate 52.

It is to be understood that FIG. 1 merely illustrates an example representation of the sensor 50 for the purposes of illustration, and any suitable shape, size, and thickness, lattice configuration, and electrode number and configuration can be used; in accordance with the following disclosure. Generally, a greater number and distribution of electrodes 56 provides a better quality signal for pressure determination; however, any suitable number and positioning of electrodes 56 can be used.

The following provides an example approach for fabricating the spatially distributed pressure sensor 50; however, any suitable fabricating approach and materials can be used. In this example, the spatially distributed pressure sensor 50 can be fabricated by having a piezoresistive carbon black/silicone composite, formed in a lattice pattern, and embedded in a sheet of silicone. In this example, a silicone rubber (such as Dragon Skin™) can be used as the substrate 52. Dragon Skin™ is a Room-Temperature-Vulcanizing (RTV) platinum cure liquid silicone, which is very strong and stretchy. In this example, a highly conductive Vulcan XC 72R carbon black (CB) can be used as the conductive material 54 when mixed into a silicone matrix. Table 1 illustrates mechanical and electrical properties of this example:

TABLE 1

| | | | Carbon Black (Vulcan XC 72R) | | |
|---|---|---|---|---|---|
| | | | | Oil | |
| Silicone (Dragon Skin ™) | | | | Absorption | |
| Tensile | Shore | | | Number | Electrical |
| Strength | Hardness | Elongation | Particle | (mL/ | resistivity |
| (MPa) | (A) | (%) | size (nm) | (100 g)) | (Ω · cm) |
| 2.75 | 20 | 663 | 30 | 192 | 4.54 |

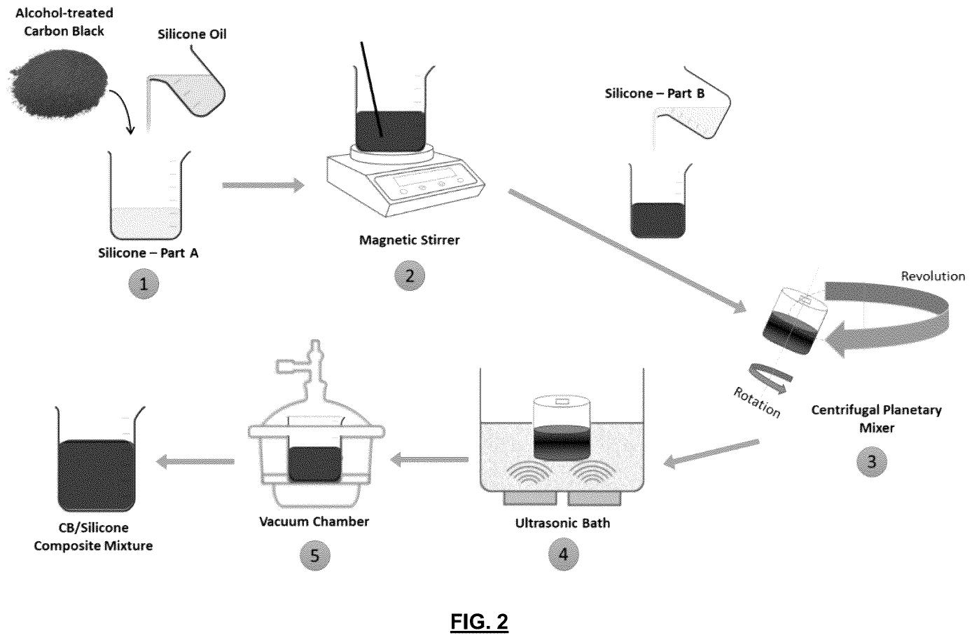

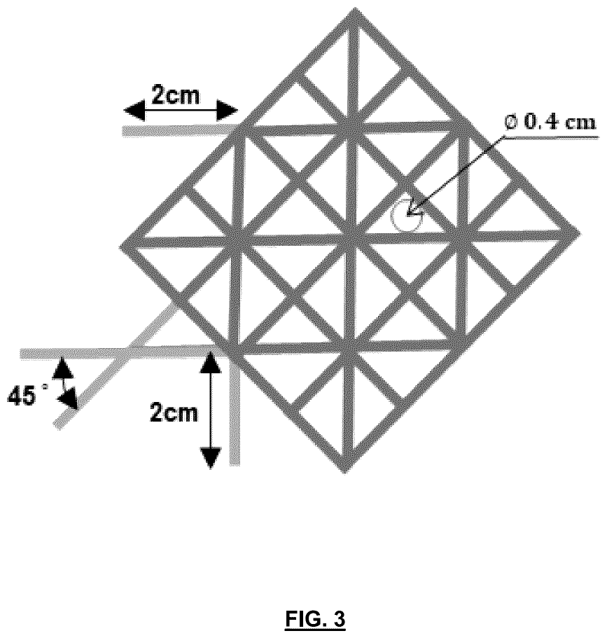

FIG. 2 illustrates a diagram of an example preparation for the example using the CB/silicone composite mixture; when used to fabricate the lattice structure. CB at 4 wt % of silicone was first soaked in isopropyl alcohol for 24 hours and then filtered and dried. The treated CB and part A of the silicone rubber were mixed with 5 wt % silicone oil, as a diluting agent, in a magnetic stirrer for 10 minutes. Part B was then added before the mixture was placed in a centrifugal planetary mixer for 6 minutes, where the rotation and revolution speeds were both set to 5 rpm. The resulting mixture was sonicated and degassed in a vacuum chamber. The centered rectangular lattice pattern shown in FIG. 3 was used in this example for the spatially distributed pressure sensor. The conductive channels were 3 mm wide, and the largest inscribed circle had a diameter of 4 mm; such that the lattice pattern covered 55% of the surface area.

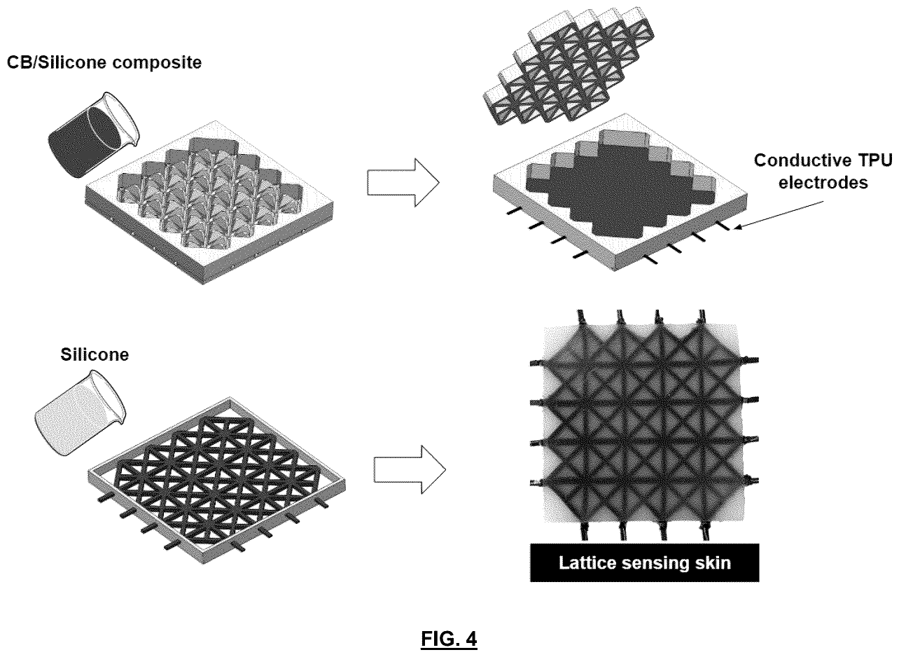

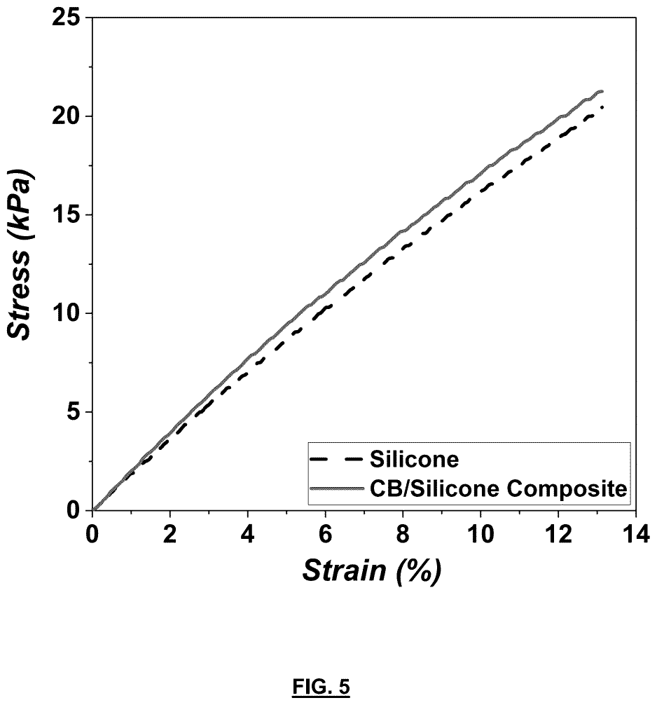

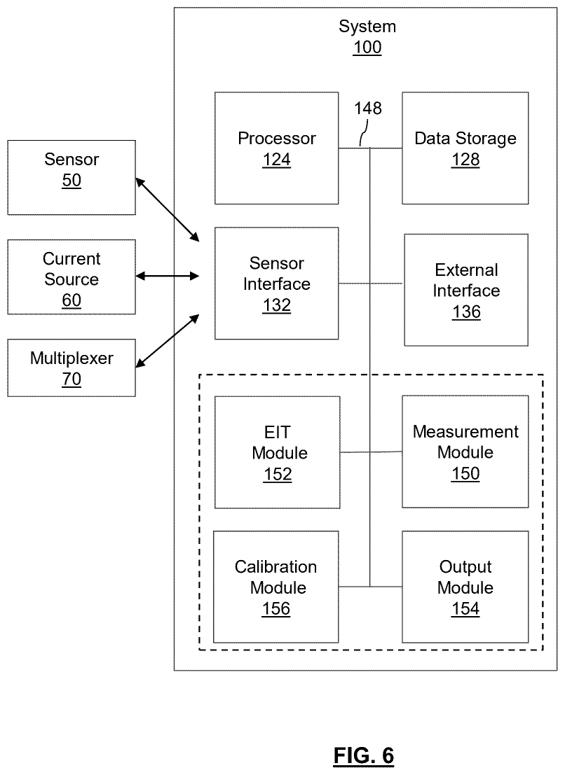

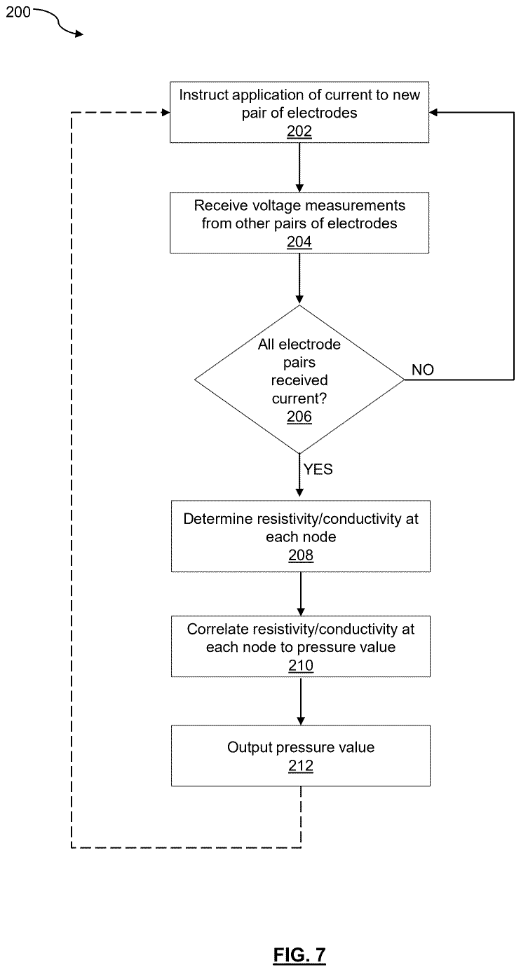

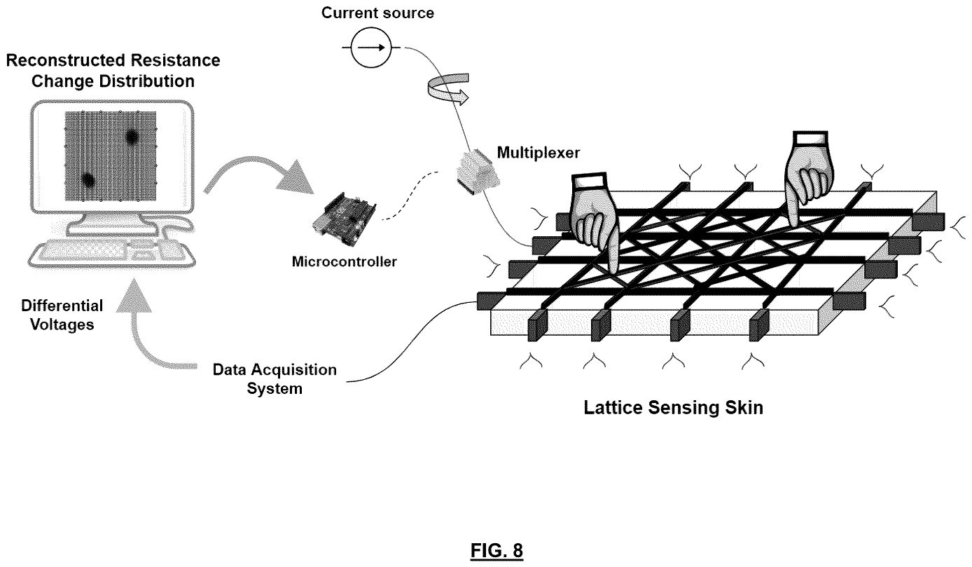

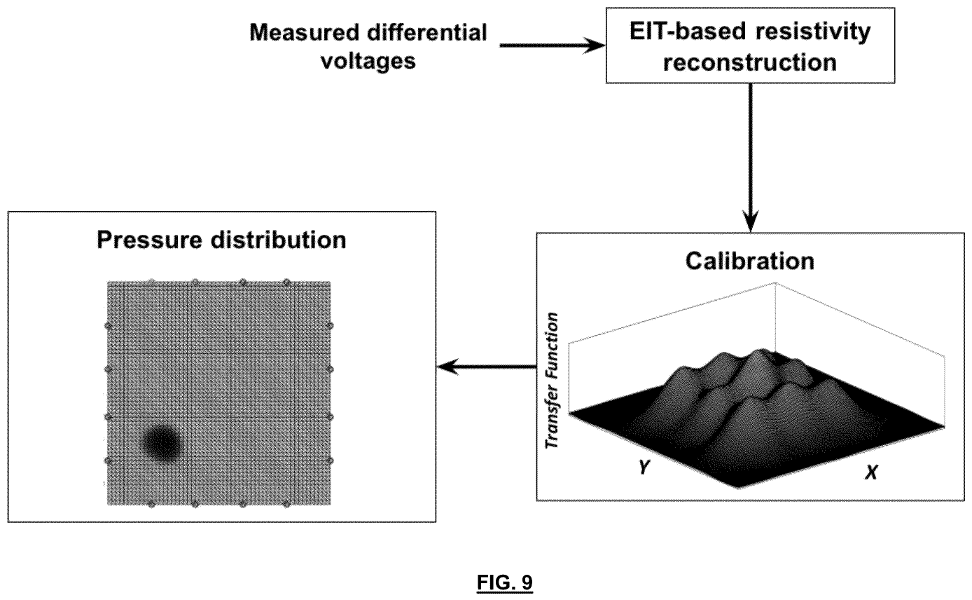

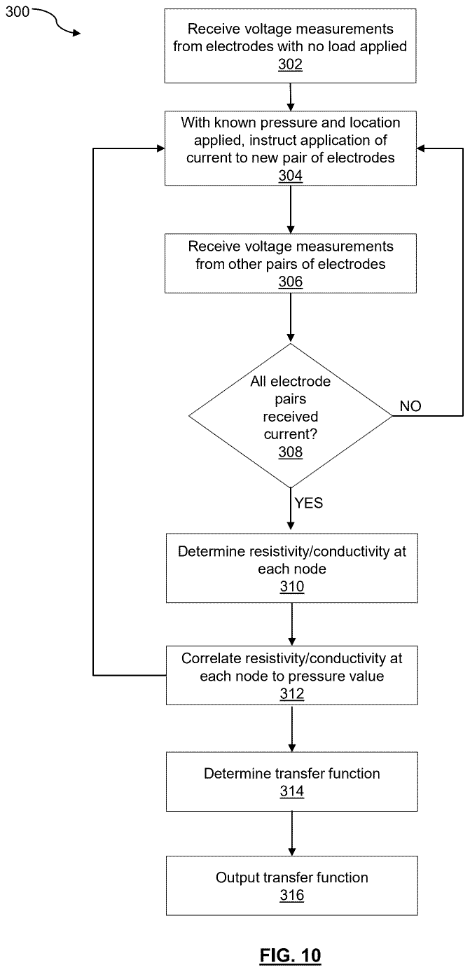

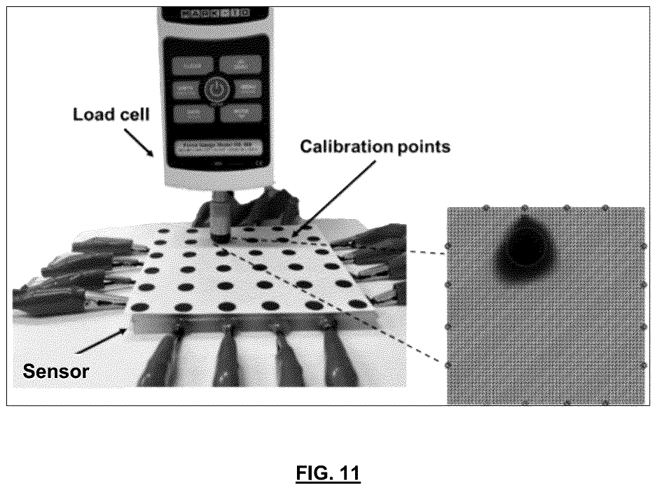

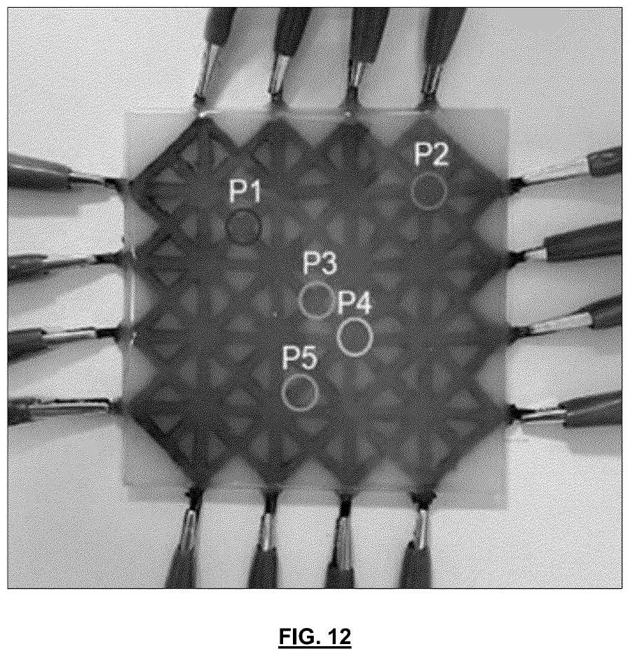

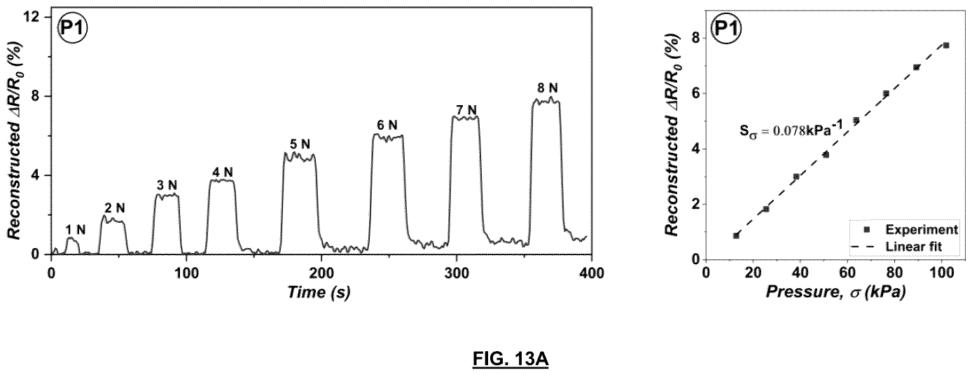

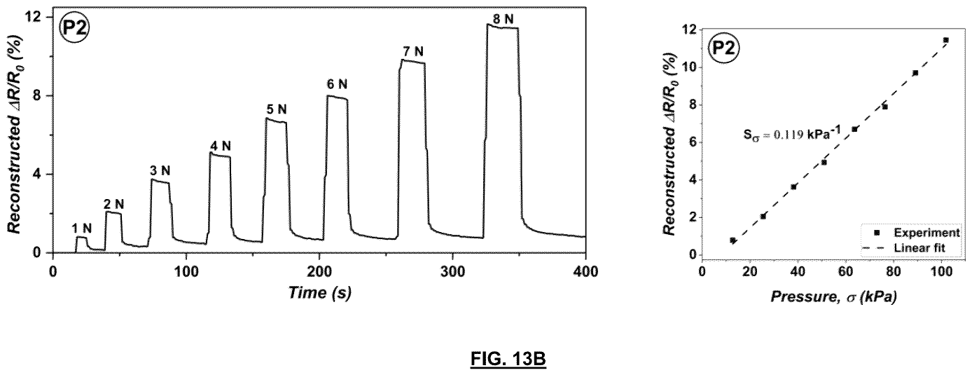

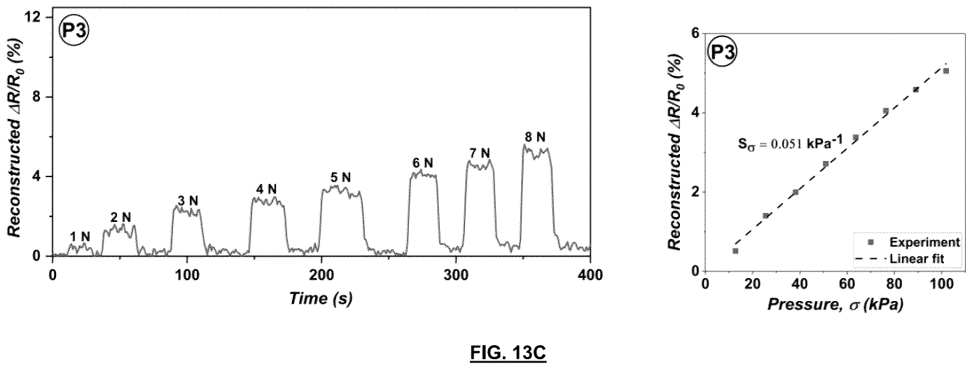

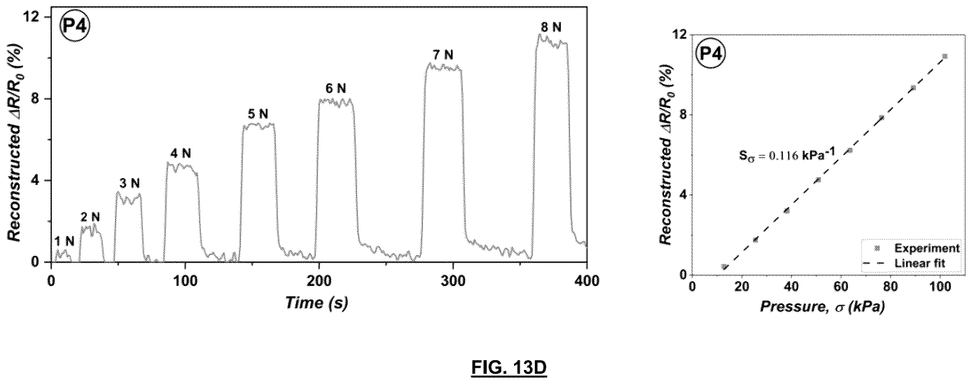

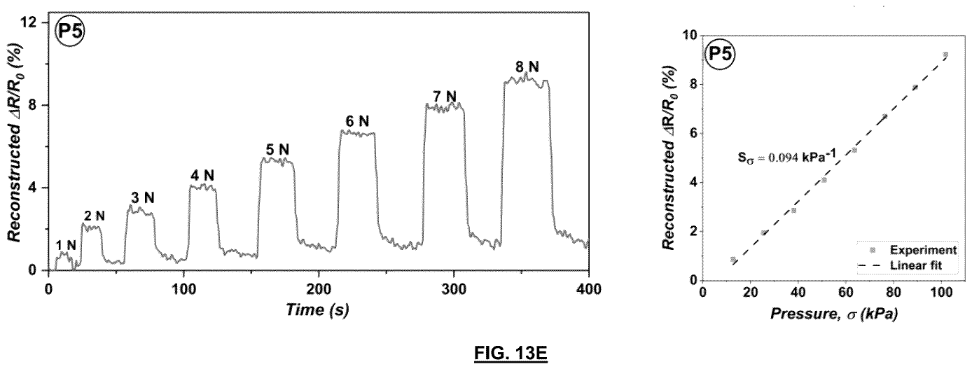

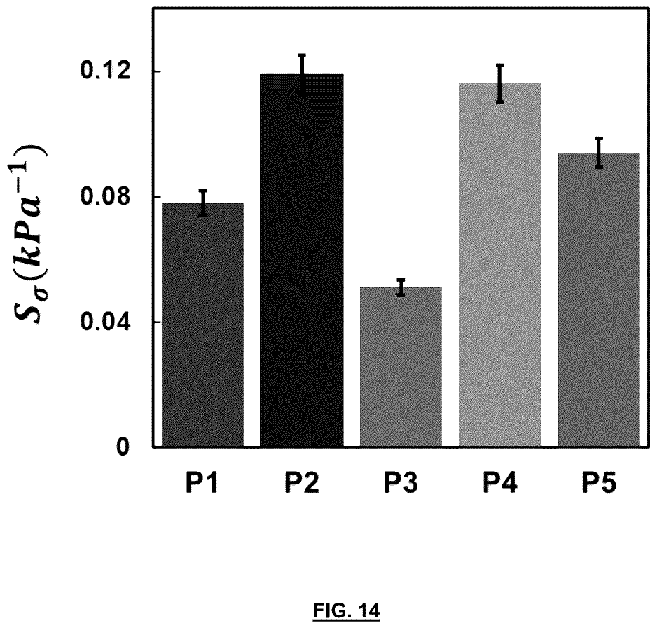

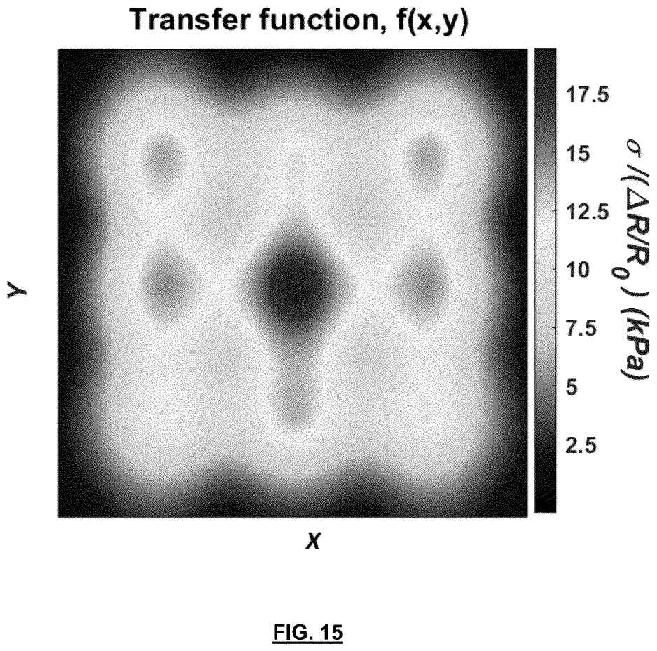

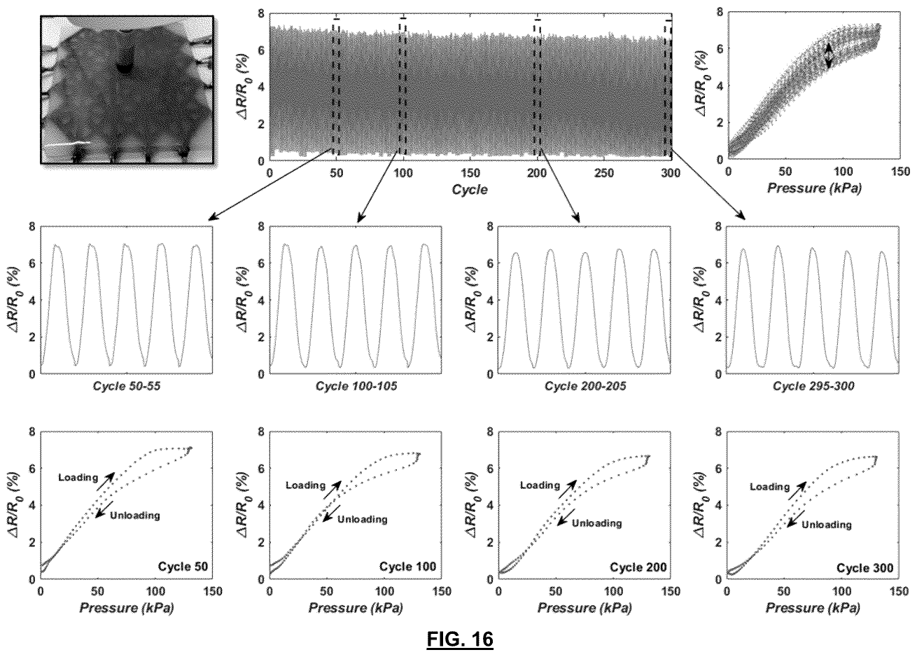

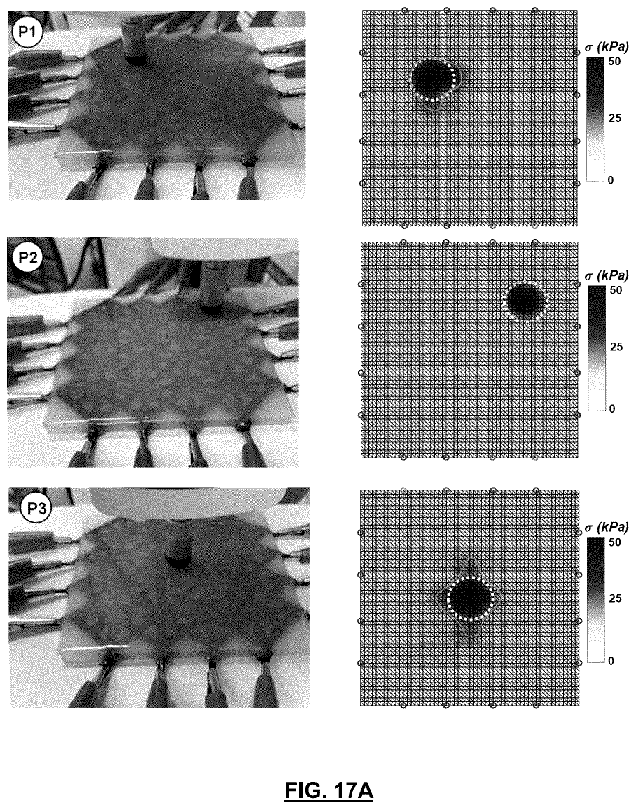

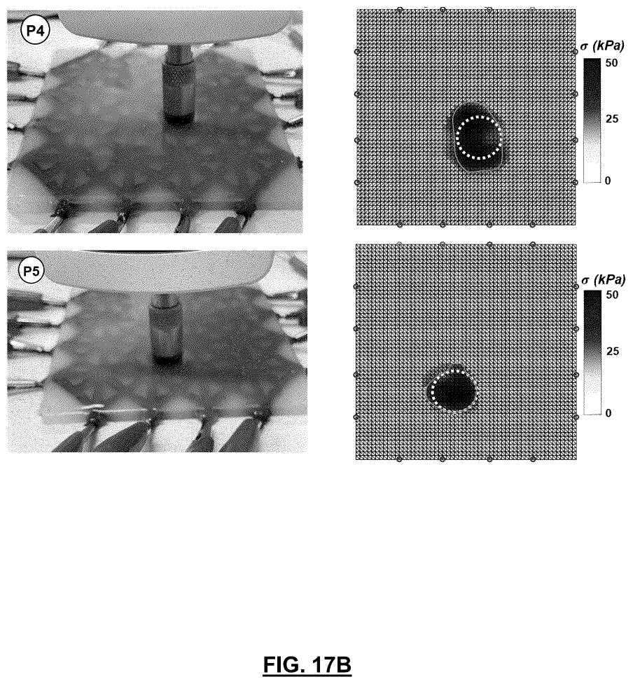

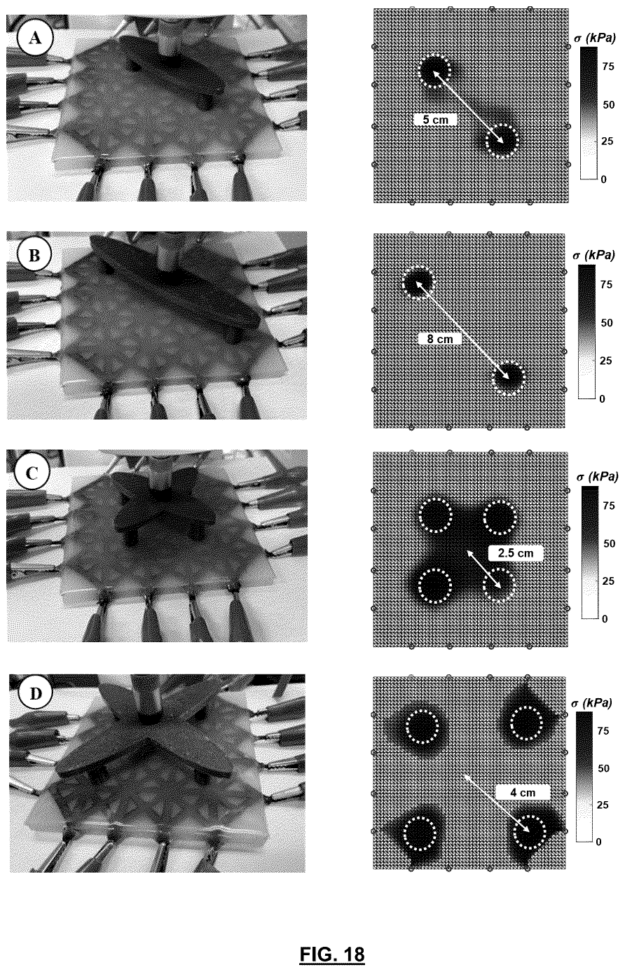

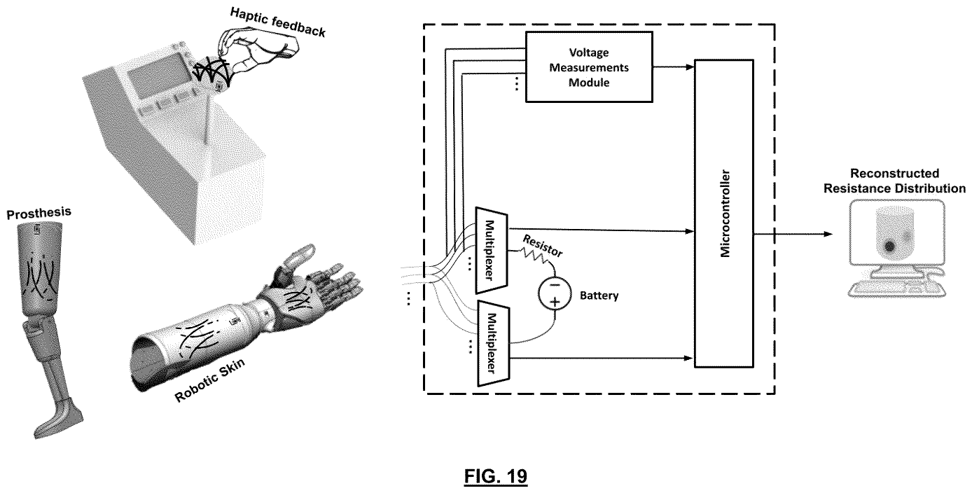

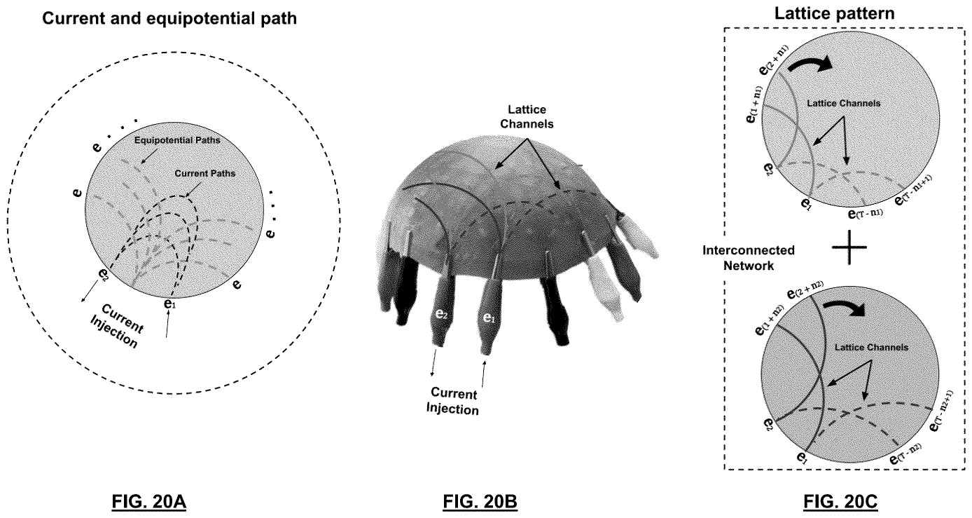

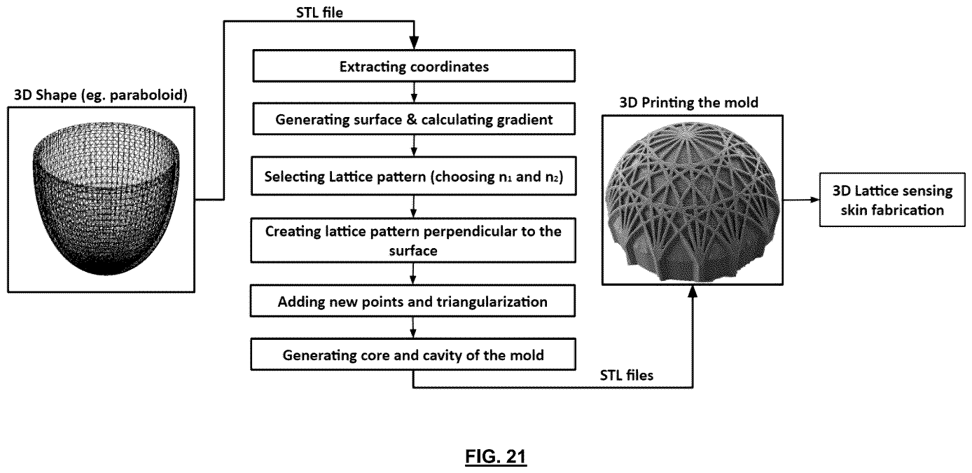

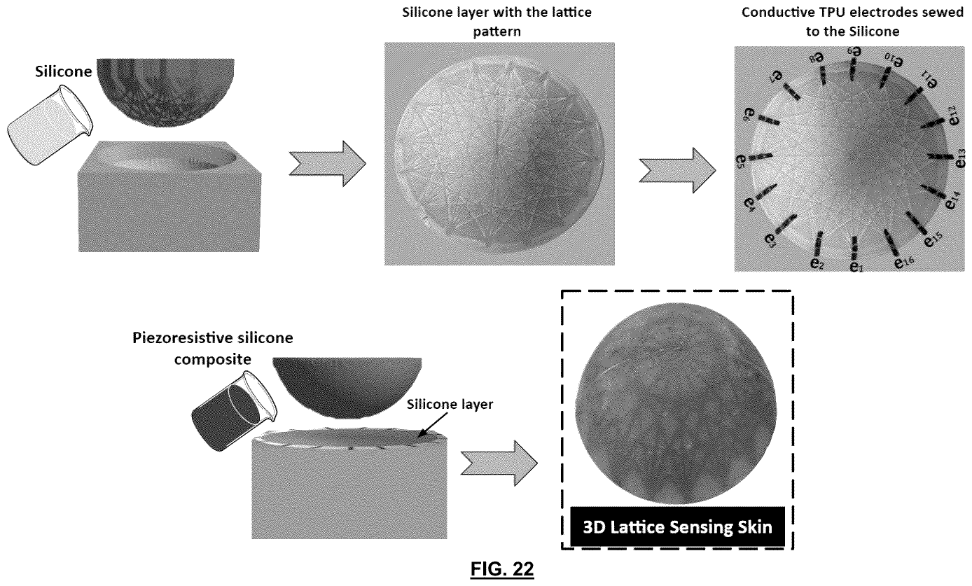

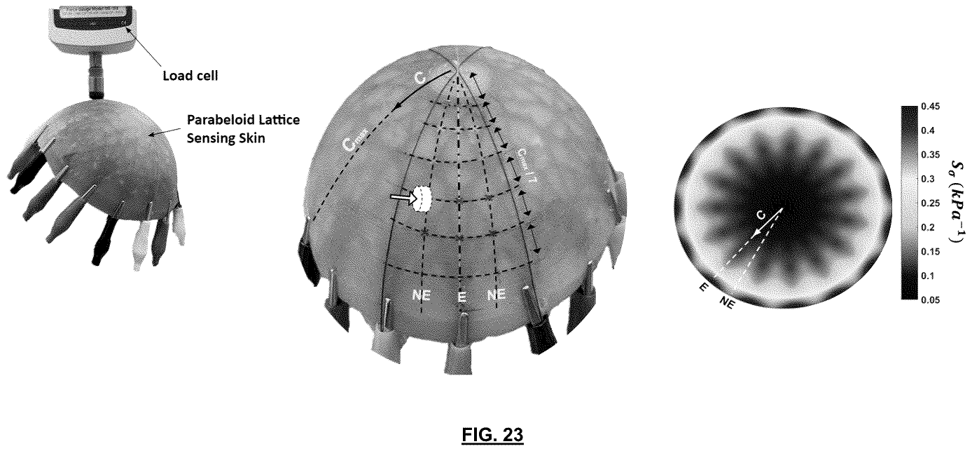

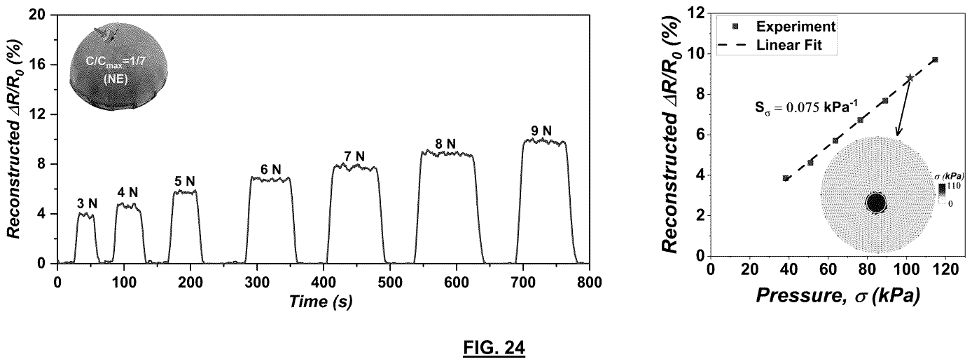

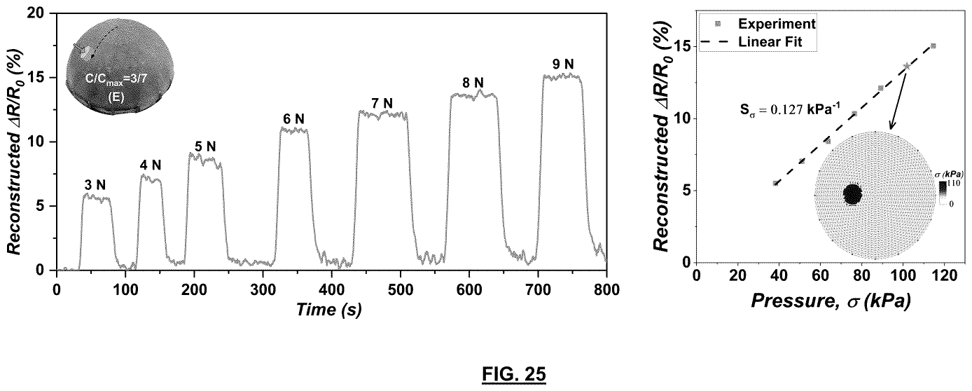

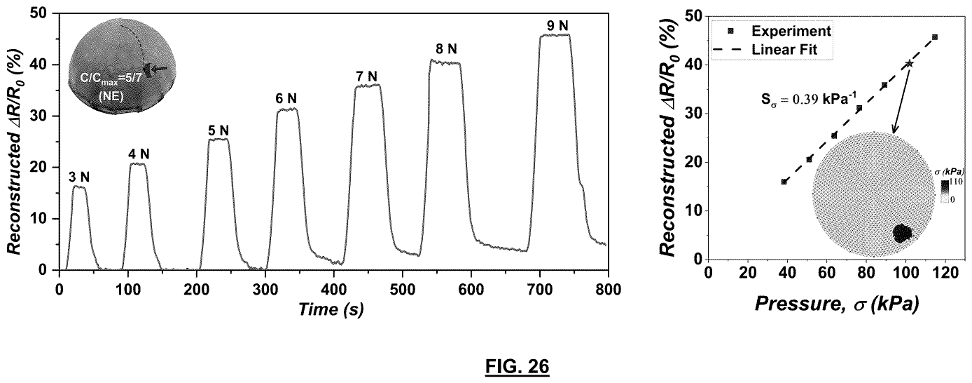

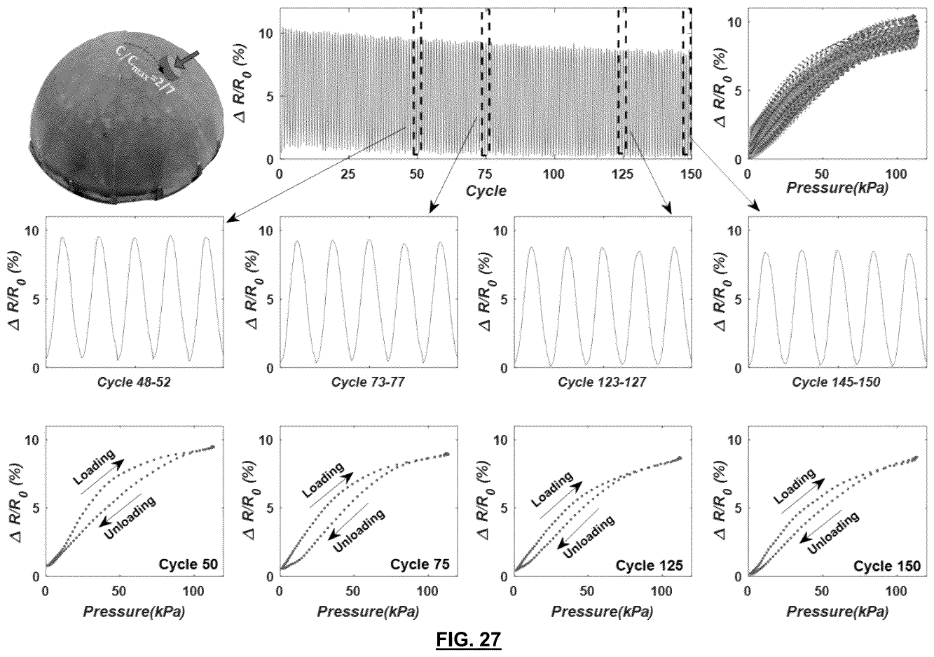

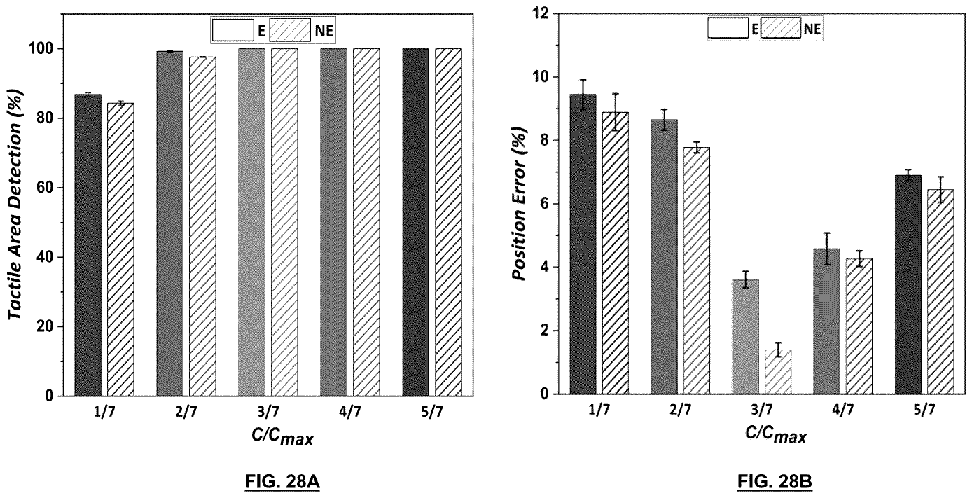

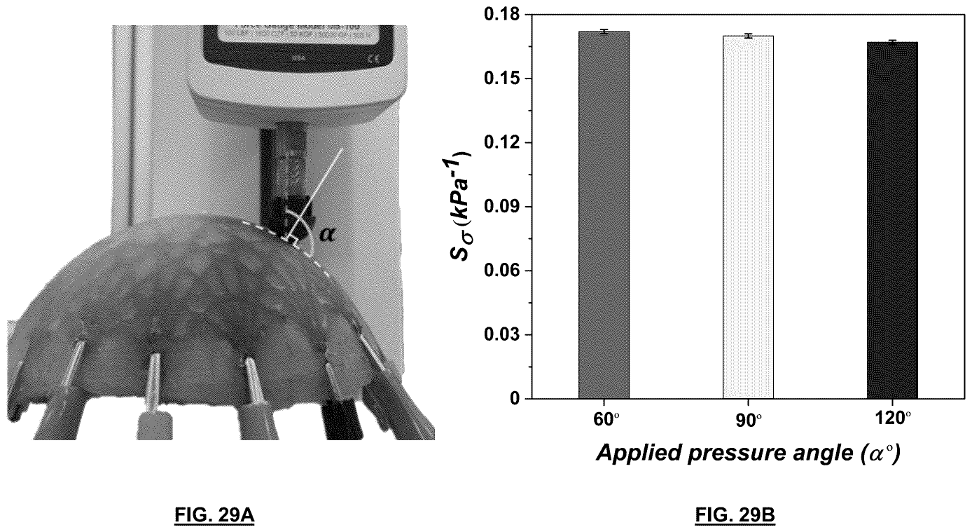

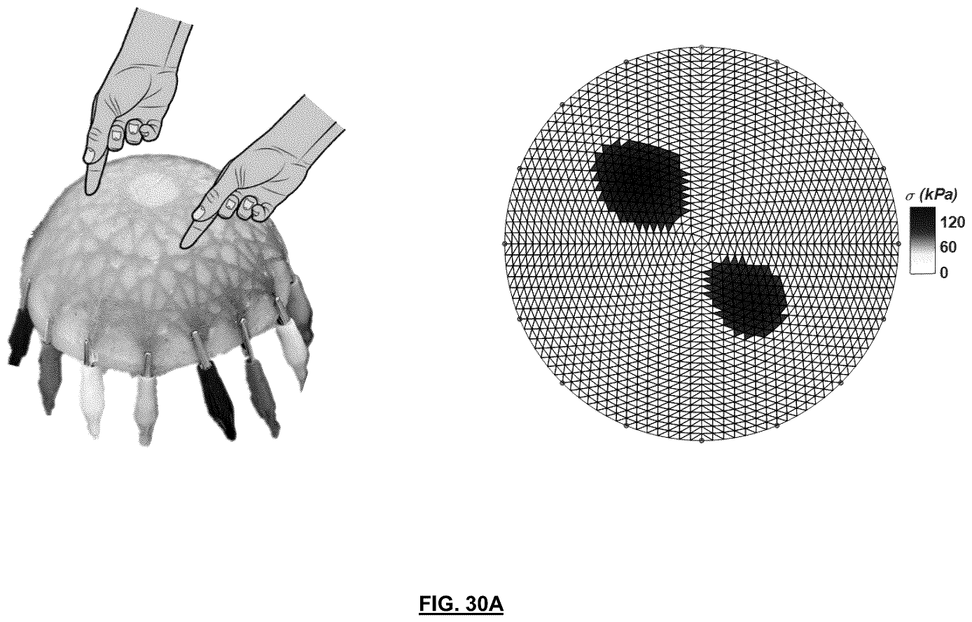

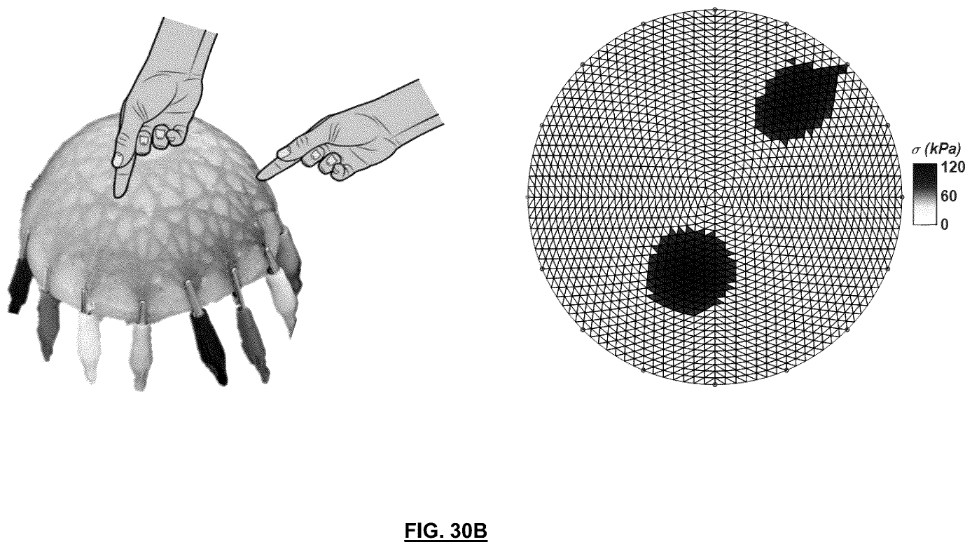

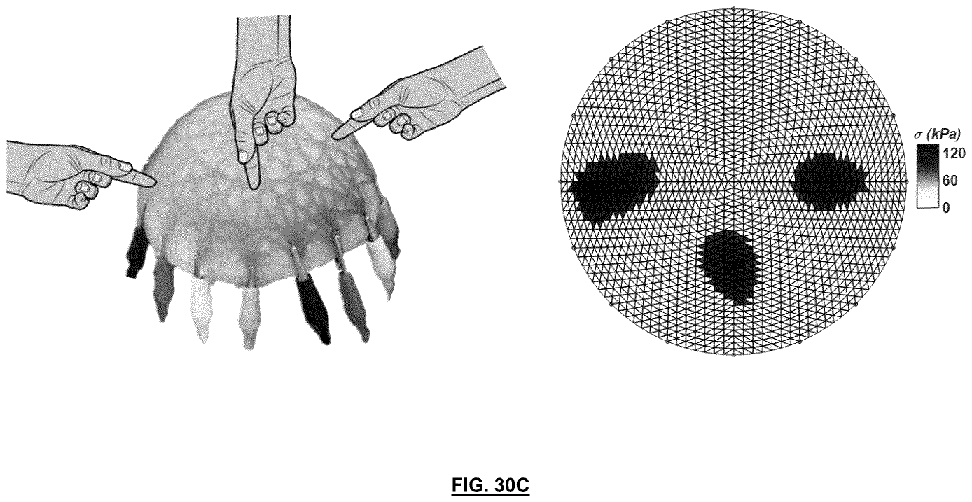

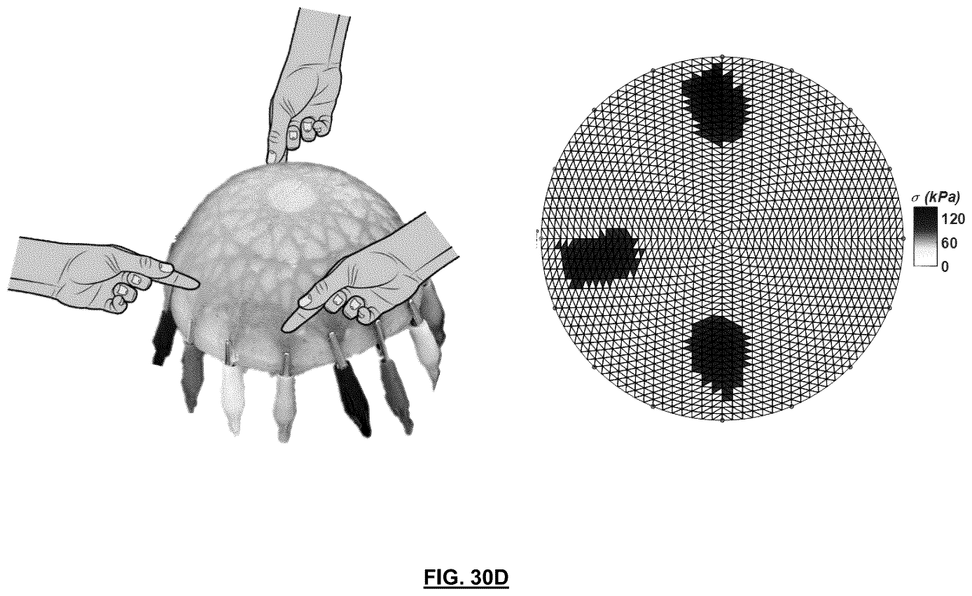

In this example, a 10 cm by 10 cm samples were fabricated using a procedure illustrated in FIG. 4. The CB/silicone composite mixture was poured into a lattice mold furnished with 16 3D-printed conductive thermoplastic polyurethane (TPU) electrodes. Once the lattice structure was half cured, it was transferred to another mold to be embedded within a layer of silicone. To gauge the compatibility of the silicone substrate and the lattice structure, tensile tests were performed on samples of silicone and CB/silicone composite, which confirmed that they have similar mechanical properties (as illustrated in the chart of FIG. 5, which illustrates stress-strain responses of silicone and CB/silicone composite).

Turning to FIG. 6, shown therein is a diagram for a system 100 for using the lattice-structured pressure sensor 50, in accordance with an embodiment. The system 100 can include a number of physical and logical components, including one or more processors 124, a data storage 128, a sensor interface 132, a user interface 136, and a local bus 148 enabling the one or more processors 124 to communicate with the other components. CPU 124 can include one or more processors. The external interface 136 enables receiving commands from a user and output information to such user (for example, via a separate computing terminal), or to communicate data with another computing device. The data storage 128 can store executable instructions for implementing the system 100, as well as any derivative or other data. In some cases, this data can be stored or synced with other databases, that can be local to the system or remotely located (for example, a centralized server or cloud repository). The sensor interface 132 interacts with the sensor 50 of the present embodiments in order to use the sensor as described herein. The sensor interface 132 can also interact with other devices for the sensing operation, such as a current source 60 and a multiplexer 70. While the above describes use of a processor, it is understood that the operations of the system 100 can likewise be implemented in other hardware or software arrangements, or the functions can be distributed among more than one computing device; for example, over a computer and a microcontroller.

In an embodiment, the one or more processors 124 execute instructions to perform operations of various conceptual modules, for example, a measurement module 150, an electrical impedance tomography (EIT) module 152, an output module 154, and a calibration module 156.

FIG. 7 illustrates a method 200 for using the lattice-structured pressure sensor 50, in accordance with an embodiment.

The system 100 performs a number of current injection and measurement iterations to perform an electrical impedance tomography (EIT). At each iteration, a constant current (for example, 0.05 amp direct-current (DC)) is to be injected into a pair of electrodes, and then voltages at each of the other electrode pairs are measured. Any suitable parameters for the current injection can be used (i.e., voltage and current used) in order to provide a suitable current density. This injection of current is repeated at each iteration for a different pair of electrodes until all electrode pairs are used. While the method 200 generally describes using DC source, it is understood that the source can be alternating-current (AC) to make admittance/impedance measurements.

At block 202, the measurement module 150, via the sensor interface 132, instructs the application of a current to a pair of electrodes 56 (acting respectively as source and ground) that have not yet received current. At block 204, the measurement module 150, via the sensor interface 132, receives voltage measurements across the other pairs of electrodes 56 (sequentially, concurrently, or in any other suitable pattern). At block 206, the measurement module 150 determines whether each pair of electrodes 56 has had current applied to it, and if not, repeats blocks 202 and 204.

At block 208, the EIT module 152 determines resistivity and/or conductivity at each node of a finite element mesh using the current injection pattern and the voltage readings; where such mesh is a two-dimensional (2D) representation of the geometry of the lattice structure. In some cases, such determination can use the inverse Maxwell equation using a finite element.

At block 210, the EIT module 152, using a calibrated transfer function, correlates the resistivity and/or conductivity value at each node in the finite element mesh to a pressure value, and produces a pressure distribution as a combination of the values at each of the nodes.

At block 212, the output module 154 outputs the pressure distribution to the data storage 128 and/or the external interface 136.

In some cases, the system 100 can repeat the measurement cycle represented by blocks 202 to 212 for further measurement cycles; for example, continuous repetition in a real-time sensing application. In an example, a 15 Hz sampling rate can be used.

In the method 200, the system 100 uses electrical impedance tomography (EIT) to map pressure over the sensor 50. In some cases, various protocols (e.g., an adjacent driving protocol) can be used to avoid current interferences and increase accuracy. The applied current can be a constant current; for example, 0.05 amp direct-current (DC).

While the method 200 generally describes injecting current into adjacent electrodes, other injection patterns may be used. For example, diagonal patterns, adaptive (mix of adjacent and diagonal) patterns, neighbouring patterns, or the like.

In view of the above, EIT is used to reconstruct a resistance (or in some cases, capacitance) distribution based on the boundary voltage measurements of the sensor 50. The reconstructed resistance can be used to map the pressure distribution of the sensing skin using the transfer function. In a particular case, reconstruction can be performed based on an inverse solution to Maxwell's equation and after the current injections into the sensor 50:

$$∇ \cdot ( σ ∇ v ) = 0 \qquad ( 1 )$$

The forward problem of Maxwells's equation is to find the potential distribution on the boundary of the conductive medium with a known conductivity distribution σ and given the current injection pattern. The forward problem can be solved using a finite element approach and by discretization of the conductive medium. The weak form of the differential equation is:

$$AY = Q \qquad ( 2 )$$

where, Y denotes the vector of potentials, Q is the current injection pattern, and A is the admittance matrix. The framework of the inverse solution is based on the forward weak form. Using Equation (2), by adding a perturbation ∂σⱼ at different elements of A and calculating θvᵢ at the boundary, the Jacobian matrix is obtained:

$$δv = Jδσ \qquad ( 3 )$$

The inverse problem can be solved considering the inverse of the Jacobian matrix in Equation (3) to calculate the conductivity ∂σⱼ changes (or resistivity φ based on the known differential voltage measurements ∂vᵢ across the boundary. The temporal changes in conductivity distribution are evaluated by taking two different sets of potential readings: instant measurements vᵢ and homogeneous baseline measurements vₕ at two different times tᵢ to tₕ and computing the difference δσ from δv using the Jacobian matrix J. The Jacobian matrix has many entries close to zero, and in some cases, the matrix inverse can lead to an ill-posed problem in which small changes in the boundary voltages can lead to a large change in the conductivity distribution. To avoid this problem, a Tikhonov regularization along with Newton's one-step method can be used to arrive at a well-posed problem and get a smooth conductivity (pressure distribution) throughout the sensor 30. This formulation can provide relative resistivity distribution values.

In some cases, a constant current is injected, in turn, into pairs of electrodes, and voltages at all other electrode pairs are measured after each injection. However, the constant current source can affect the dynamic nature of reconstructions. To accelerate reconstruction, the system 100 can have the constant voltage source (e.g., a 3.2V battery voltage source) to inject current into pairs of electrodes. The voltage source can be significantly faster than using the current source; where the speed is controlled by a switching speed of the multiplexer and the measurement speed of voltage. In some cases, to measure the value of the current injected in each pair, a voltage divider resistor can be added to the circuit. The measured current value normalizes the measured differential voltages after each injection. Differential voltages can be received by the sensor interface 136 to dynamically solve the EIT inverse problem and determine pressure and location values. The adjacent driving protocol was used to inject current between sets of electrodes.

FIG. 8 illustrates an example implementation of the system 100. In this example, the current source 60 is a Lakeshore current source via the multiplexer 70 to provide current injection and voltage measurements. In this example arrangement, sixteen electrodes 56 were placed around the boundary of the lattice of conductive material 54. After all the iterations, 208 differential voltage measurements are made. Tikhonov regularization and a single iteration of the Gauss-Newton reconstruction algorithm were performed on 3136 triangular elements. The reconstructed changes in relative resistance

$$( \frac{Δ R}{{R}_{0}} )$$

at different pressure values and at different points over the sensor 50 were used to derive a transfer function to be used for reconstructing the pressure distribution (as illustrated in the example shown in the diagram of FIG. 9).

Tikhonov's regularization and Gauss-Newton reconstruction are commonly used approaches for image reconstruction in EIT. In EIT, the object being imaged is typically divided into a finite number of elements, such as triangular or rectangular elements, in order to discretize the problem and simplify the computation.

In this example, the choice of 3136 triangular elements is based on desired spatial resolution and computational efficiency. The number of elements and the element size affect the spatial resolution of the reconstructed image, with smaller elements generally resulting in higher resolution but requiring more computational resources. The number of elements is typically chosen such that a balance between resolution and computational efficiency is maintained.

Tikhonov regularization is a method for regularizing ill-posed inverse problems by adding a penalty term to the objective function that favors solutions with smoothness or simplicity. EIT can use Tikhonov regularization to minimize the difference between measured and predicted voltages while also ensuring the smoothness or simplicity of the reconstructed image.

Gauss-Newton reconstruction is an iterative approach to minimize the difference between measured and predicted voltages by iteratively updating the conductivity distribution of the object being imaged.

Calibration of the sensor 50 allows for the determination of sensitivity values at various locations on the sensor 50. FIG. 10 illustrates a method 300 for calibrating the lattice-structured pressure sensor 50, in accordance with an embodiment.

At block 302, in some cases, the measurement module 150, via the sensor interface 132, receives voltage readings from around the boundary, without no load being applied on the sensor 50, as homogeneous values.

At block 304, while known pressure is applied at a defined location on the sensor 50, the measurement module 150, via the sensor interface 132, instructs the application of a current to a pair of electrodes 56 (acting respectively as source and ground) that have not yet received current. At block 306, the measurement module 150, via the sensor interface 132, receives voltage measurements across the other pairs of electrodes 56 (sequentially, concurrently, or in any other suitable pattern). In some cases, the measurement module 150 can calculate the change in voltage relative to the homogenous value. At block 308, the measurement module determines whether each pair of electrodes 56 has had current applied to it, and if not, repeats blocks 202 and 204, while the known pressure remains applied.

At block 310, the EIT module 152 determines resistivity and/or conductivity at each node of a finite element mesh using the current injection pattern and the voltage readings; where such mesh is a two-dimensional (2D) representation of the geometry of the lattice structure (which can be three-dimensional (3D)). In some cases, such determination can use the inverse Maxwell equation to determine changes in resistivity and/or conductivity at an area or node of the finite element mesh.

The inverse Maxwell equation is a mathematical equation that is generally used to determine the resistivity or conductivity distribution of an object from electrical measurements obtained on its surface. The equation is based on the principle that the electrical current flowing through an object is related to its resistivity or conductivity distribution. The inputs are voltage measurements, and the outputs are the conductivity values at nodes of finite element mesh.

Determining resistivity or conductivity using the inverse Maxwell equation can, in an example, include:
Defining an object geometry. The object being imaged is typically divided into a finite number of elements, such as triangular or rectangular elements, to discretize the problem and simplify the computation.
Solving a forward problem. The forward problem involves calculating the electrical potential or current density inside the object for a given conductivity distribution. This is typically done using a finite element approach, which approximates the solution to the inverse Maxwell equation for a given conductivity distribution.
Defining the electrical boundary conditions. The electrical boundary conditions at the surface of the object; such as voltage measurements (non-injecting electrodes) and current injection at the driving electrode.
Performing regularization (Tikhonov): The objective function is a mathematical expression that quantifies the difference between measured and predicted electrical boundary conditions. The goal is to find a conductivity distribution that minimizes this difference.
Solving the inverse problem: The inverse problem involves finding a conductivity distribution that minimizes the objective function. This is performed using an optimization algorithm, such as the Gauss-Newton method.

At block 312, the EIT module 152 correlates the resistivity and/or conductivity value at each node in the finite element mesh to the known pressure value that was applied on the sensor 50.

Blocks 304 to 312 are repeated for other pressure values at the same location on the sensor 50, and then repeating this application of different pressures at other locations on the sensor 50. Generally, correlations to a number of different locations on the sensor 50 are required to determine a relationship between the change in resistivity and/or conductivity and the location of the applied pressure; where a greater number of locations and pressures will provide a greater pressure range for later determination by the system 100.

At block 314, the calibration module 156 determines a transfer function correlating change in resistivity and/or conductivity to pressure for the finite element mesh, based on the relationship between the change in resistivity and/or conductivity and the applied pressure. Using a sensitivity slope of the points of the sensor 50 tested above, the calibration module 156 interpolates in order to calculate a sensitivity value for all, or a substantial portion of, the points on the sensor 50. In this way, the interpolation yields a transfer function, which can be used to interpolate pressure values for the entire sensor 50 based on the measured voltage values.

In some cases, to determine the transfer function, there are a set of points on the sensor 50. For each point, a (linear) relation between pressure and resistance change can be determined; i.e., there can be transfer functions for several distinct points. These transfer functions (slope of the response lines) can be used to obtain a 2D transfer function for the entire sensor 50 area through bicubic interpolation. The 2D transfer function represents the line slope at each point on the surface; i.e., relates the relative resistance change over the surface to the applied pressure.

At block 316, the output module 154 outputs the transfer function to the data storage 128 and/or the external interface 136.

The choice of points on the sensor 50 used for calibration generally depends on the sensor's symmetry. For symmetric sensors, such as circular sensors, the system 100 will generally only need to examine a few points on a slice of the sensor 50 in order to replicate the results. However, for other shapes of sensors, such as for square-shaped sensors, calibration may be necessary on an eighth of the sensor and grid points need to be considered where calibration is to be performed.

The number of calibration points which may be needed can depend on the shape and symmetry of the sensor. For example, square-shaped sensors are often calibrated using only an eighth of the sensor area. This is because a square has 4 lines of symmetry, and therefore, the remaining seven eighths will have the same response. By only using a portion of the sensor area, calibration can be performed more efficiently. In circular sensors, there could be infinite lines of symmetry (depending on the lattice pattern). In this case, calibration can be performed on a single slice between two electrodes. This slice can be used to represent the entire sensing area, making calibration more efficient and straightforward.

In an example of calibration, sensors 50 were subjected to multiple loading and unloading cycles, with maximum magnitudes ranging from 1N to 8N (12-100 kPa), at multiple points on a calibration grid. This loading is illustrated in the photograph of FIG. 11. Loading was applied at a rate of 10 mm/min. In this example, the pressure was applied to points P1 to P5 shown in FIG. 12. FIGS. 13A to 13E shows sensor response at the five locations, P1 to P5, respectively, at distinct points in the lattice configuration. Points P1 and P3 are both 4-connection nodes, but located near the boundary and centre, respectively. Points P2 and P4 are both 6-connection nodes, but located near the boundary and centre, respectively, and point P5 is on a path between nodes. While the response was linear at all points, the sensitivity varied depending on the lattice configuration at each point. This was taken into account for generation of the spatial transfer function.

FIG. 14 is a chart showing a comparison of sensitivity values (S_{σ}) at the five distinct loading points on the sensor 50. P2 and P4 have the highest values of sensitivity because they are 6-connection nodes. P2 offers higher sensitivity because it is closer to the electrodes. P1 and P3 show lower sensitivities because they are both at 4-connection nodes. P3, which is in the middle, has the lowest sensitivity as it is the farthest from the electrodes. P5, which is in between 6-connection and 4-connection nodes, is less sensitive than P4 and more sensitive than P1. The transfer function at a given point on the sensing surface of the sensor 50 depends primarily on two variables: the distance from electrodes and the lattice configuration at that location. FIG. 15 displays a two-dimensional transfer function ƒ (x, y), derived by interpolating the transfer functions obtained for the five distinct points on the sensor. The sensitivity at boundaries was set to zero to reduce noise.

To determine the long-term performance of the sensor 50, 300 cycles of loading to 134 KPa was applied at the center of the sensor 50 (at point P3). As illustrated in FIG. 16, the sensor's response was highly repeatable over these 300 cycles and showed a slight drop in maximum relative resistance of only ~0.5%, suggesting long-term stability. The sensor had a hysteresis of ~12% on average at 80 kPa. The response drift at 80 kPa was ~8-15% at cycles 50, 100, 200 and 300.

The sensor 50 of the present embodiments has a number of suitable applications; for example, to detect and quantify pressure (or touch) points in robotics, wearable electronics, and sports equipment, among others. The present inventors investigated the sensor's 50 performance in single, double, and quadruple touch sensing.

FIGS. 17A and 17B presents the sensor's response to an applied pressure of 40 kPa at points P1 to P5. The reconstructed pressure distributions show very good spatial resolution at all five locations. A tactile area detection (TAD) metric was defined as the ratio of the loaded area (dashed line) to the area of the reconstructed pressure of least 75% of the nominal applied pressure. The TAD ratio varied between 73% to 100%. It was lower for points farther from the electrodes, 73% for P3 and 75% for P4, and higher for points closer to the electrodes, 81%, 100%, and 92% for P1, P2, and P5, respectively. Unlike other spatially distributed sensing approaches, the lattice sensor 50 offered high sensitivity in the center.

FIG. 18 illustrates response to double and quadruple touch experiments performed on the sensor 50; where each touch point was subjected to a pressure of 70 kPa. FIG. 18 shows an experiment with two points spaced 5 cm apart, two points spaced 8 cm apart, four points that were each 2.5 cm apart from the center, and four points that were each 4 cm apart from the center. The reconstructed pressure distributions were consistent with the applied pressure configurations. Generally, the distinguishability of the touch points was better the farther apart they were.

The sensor 50, having a lattice arrangement for the conductive material, substantially reduces complexity of fabrication by eliminating internal wiring, because measurement electrodes 56 are located only at the boundary. The example experiments, described above, illustrate that the sensor 50 produces larger relative resistance changes in response to applied pressure than other spatially distributed sensors; and can thus provide higher sensitivity and better spatial resolution. The sensor 50 had a linear response to a pressure range of 12 kPa to kPa and was able to detect and quantify single-point and multi-point touch accurately and precisely. The spatial resolution was 1.4 mm. Depending on the lattice configuration at the touch location, the TAD (tactile area detection) ratio varied from 73% to 100% of the touch area. 300 loading cycles at the center of the skin led to only ~0.5% reduction in the maximum relative resistance change, which suggests long-term stability.

While the examples of sensor 50 shown herein illustrate a symmetric centered rectangular lattice for the conductive material 54, the lattice pattern can be non-symmetric and provide customized sensitivity distribution and spatial resolution. The lattice configuration can be optimized and tailored to provide a desired accuracy and resolution required for different applications. For example, having more density of conductive material in the lattice for higher resolution measurements at some sections of the sensor 50, and lower densities at other sections of the sensor 50.

While the above examples of sensor 50 illustrate a substantially planar configuration, the sensor 50 can also conform to non-planar configurations, such as with 3D shapes. The 3D shapes likewise provide high sensitivity and spatial resolution for detecting various types of stimuli. The sensor 50 also includes an interconnected lattice structure of conductive material embedded in the substrate and includes boundary electrodes. The lattice structure for the conductive material 54 generally covers a sensing area and has a high spatial resolution and sensitivity because of alignment with equipotential lines. The lattice structure can have any suitable arrangement and density of conductive material, so long as any gap between lines of conductive material is not so great as to no longer provide meaningful pressure measurements, as determined using the method described herein.

The present inventors also conducted example experiments to test the performance of the sensor 50, where the sensor 50 has a 3D shape. The experiments included single/multi-touch, cyclic, and oblique loadings. The 3D-shaped sensor 50 provided a linear response (R²=0.99) at all points with a sensitivity range of around 0.1 kPa⁻¹. The tactile area detectability of the 3D-shaped sensor 50 was assessed by using a tactile area detection (TAD) metric that compares the actual loaded area to the reconstructed image area corresponding to at least 75% of the maximum applied pressure. The average TAD ratio was 96% at different points, indicating the sensor's ability to detect the actual pressure area. The position error, which measures the difference between the actual and reconstructed radii of a pressure point, was also evaluated. Generally, the 3D-shaped sensor 50 of the experiment expanded more when pressed outward (such as 120 degrees), resulting in lower sensitivity than when pressed inward. Double and triple-touch experiments showed that the reconstructed pressure distributions are consistent with the applied pressure configurations and are at times better when pressure points are farther apart.

General approaches have used elastomeric sensors to provide flexibility and stretchability, such as for skin-like interactive applications. Elastomeric sensors can use pressure sensing properties as sensing mechanisms. For example, an array of elastomeric piezoresistive composites to measure the interaction forces of a prosthetic socket with a limb. In these general approaches, sensors can be flexible and can be attached to 3D shapes, but can only measure one-dimensional (1D) characteristics and generally lack scalability. Some approaches cover a large sensing area with the use of an array of conductive elastomeric material in rows and columns, with each intersection forming a single capacitive sensor. Other approaches use an array of capacitors measuring an exerted force but has practical limitations, such as fabrication complexity for large and three-dimensional (3D) geometries, complex wiring, and repair difficulties. In addition, such approaches show an unpredictable capacitive response due to the unstable overlaps between capacitive areas and capacitive interaction with the human body.

Embodiments of the present disclosure can use EIT to reconstruct 3D resistivity distributions for conductive media by determining boundary values using potential measurements. Conductive elastomeric materials, using EIT, generally solve the scalability and wiring complications of the aforementioned approaches. EIT has generally been applied to flat surfaces with uniformly distributed conductive elastomer covering the sensing area. In some approaches, a one-dimensional conductive ink can be applied on to a flexible material to measure pressure distribution on a spatially distributed sensor skin. In such approaches, fractional resistance changes of uniform skin sensors during local pressure are small, leading to relatively weak spatial resolution. As a result of the low sensitivity in some regions of the uniformly distributed skin, other approaches that use EIT for tactile sensing have measured pressure/force distribution qualitatively rather than quantifying them; which is a significant limitation in their application and use.

In particular cases, the sensor 50 can be formed into a 3D convex shape. A potential application of the 3D convex-shaped sensor 50 is in the field of robotics, where it could be used to give robots a sense of touch and the ability to interact with their environment in a more natural and intuitive way. Other potential applications for the 3D convex-shaped sensor 50 include haptic feedback systems for virtual reality and augmented reality applications, as well as in medical devices, such as prosthetics and assistive devices. FIG. 19 illustrates an example hardware implementation of the sensor 50 and the system 100 for various 3D shaped applications.

The 3D convex-shaped sensor 50 comprises the conductive material lattice network embedded in the substrate. The lattice shaped conductive material forms the 3D-shaped sensing skin, covering the sensing area with piezoresistive material. FIG. 20A shows current paths and equipotential lines when the current is injected into two adjacent electrodes. Using the method 200, equipotential lines on the electrode's locations can be measured and compared to the no-load condition. The pressure point can be located by measuring the potential change and checking the electrodes involved. The potential on the boundary will change more due to the applied pressure if the lattice pattern of the sensor 50 matches the equipotential line (illustrated in FIG. 20B). This enables the system 100 to locate pressure points and values more easily than for a uniformly distributed sensor. Therefore, interconnected patterns, such as the patterns illustrated in FIG. 20C, are considered because they are close to equipotential lines and can cover the entire surface. FIG. 20A illustrates current paths and equipotential lines in an adjacent current injection to e₁, e₂ of the sensor illustrated in FIG. 20B. FIG. 20C illustrates the interconnected lattice network based on the equipotential paths; where n₁ and n₂ are design criteria and can be chosen for a specific sensitivity and spatial resolution.

To create the interconnected lattice network, electrodes can be numbered from e₁, e₂, . . . , eᵣ and connected with a layout where T denotes the total number of electrodes. The interconnected network can be created by connecting an i^{th} electrode, eᵢ, to the electrode eⱼ and eₖ, and repeated for all electrodes (as illustrated in FIG. 20C). j and k can be assumed using Equation (4), below, and by choosing n₁ and n₂ constants based on the application and the required spatial resolution. n₁ and n₂ are suggested to have different values ranging from 1<n₁<n₂<T/2. n₁ with lower values can create conductive channels close to the boundary of the sensor and n₂ with higher values can lead to the conductive channels closer to the center of the sensor. It is possible to increase the lattice channels by connecting more electrodes via a pattern that covers a larger area (improves spatial resolution), but this can reduce their sensitivity. For the example experiments of the 3D-shaped sensor, 16 electrodes (T=16) were located around the boundary and n₁ and n₂ were 4 and 7, respectively. For different applications, these n₁ and n₂ can be adjusted, as they were assumed for a general application.

$$Interconnected network = \{ \begin{matrix}j = i + {n}_{1} & i \leq T - {n}_{1} \\ k = i + {n}_{2} & i \leq T - {n}_{2} \\ j = i + {n}_{1} - T & i > T - {n}_{1} \\ k = i + {n}_{2} - T & i > T - {n}_{2}\end{matrix} \qquad ( 4 )$$

In the example experiments, compression molding was used to fabricate the 3D-shaped sensor 50. In an example, computer aided design (CAD) files for the mold, for 3D printing fabrication of the sensor 50, can be automatically generated using the flowchart illustrated in FIG. 21. The sensor's 3D geometry coordinates can be extracted from the CAD file. The boundary of the surface can then be projected in the 2D plane. Using the extracted coordinates, electrode locations can be specified on the 2D border by splitting the boundary into equal intervals. The desired lattice pattern coordinates can be defined by connecting the electrodes with the layout in the 2D plane of the electrodes. Conductive channels are generally created perpendicular to the 3D geometry of the sensing skin. Therefore, the gradient function of the 3D surface is determined. The 2D lattice pattern can be projected into the 3D surface of the sensor and expanded along a gradient direction to generate a 3D mold core. By combining these new points with the previous points on the surface, the final shape of the mold core can be generated. A new surface containing lattice channels can be created and saved by triangularizing the points, for example, as a stereolithography (.STL) file. The mold cavity can be prepared according to the given geometry, along with an offset for the thickness of the sensor. The portions can be 3D printed for use in the fabrication of the 3D-shaped sensor. In the example experiments, a cylindrical shape, with a paraboloid bottom having a diameter of 8 cm and a height of 12 cm, was used.

FIG. 22 shows an example fabrication procedure for the 3D-shaped sensor 50. The silicone material can be poured into a mold cavity. The lattice pattern is created on the silicone substrate by pushing a mold core with the lattice pattern. After curing, 3D printed conductive TPU electrodes can be sewn on the border of the silicone substrate. Piezoresistive mixture of Carbon black (Vulcan XC 72R) 4% wt/Silicone (Dragon Skin™) was prepared and pressed into the silicone substrate. Another layer of silicone was applied once the conductive layer was half-cured to protect the sensing channels. Tension tests were conducted on silicone and CB/silicone composite samples to determine the compatibility of the two skin components. Results showed that silicone and silicone composite had similar mechanical properties.

In the example experiments, to reduce the computational complexity of modeling, a paraboloid shape was mapped into a circle with a radius of one. The radius of the point on the reconstructed image was determined by dividing the arc length at the point from the center (C) by the maximum arc length (Cₘₐₓ) (shown in FIG. 23). C/Cₘₐₓ denotes arc ratio, which is being used for all the calculations. The lattice sensing skin was calibrated at different arc ratios and two different angles (highlighted points on FIG. 23). The angle change at the same arc ratio can affect the sensitivity, and because of this, two conditions of being on an electrode (E) or not on an electrode (NE) were measured. Forces between 3N to 9N were applied to determine the sensitivity distribution of the sensor.

FIG. 23 shows sensitivity distribution conducted at ten distinct points. The results of one such point with

$$C / {C}_{m ax} = \frac{1}{7} ( not on an electrode )$$

is shown in FIG. 24. The results of another such point with

$$C / {C}_{m ax} = \frac{3}{7} ( on an electrode )$$

is shown in FIG. 25. The results of another such point with

$$C / {C}_{m ax} = \frac{5}{7} ( not on an electrode )$$

is shown in FIG. 26. The actual pressure point is highlighted with a line in the reconstructed pressure distribution.

Time history and reconstructed images to the load from 3 to 9 N at three locations are shown in FIGS. 24 to 26. The sensor 50 offers a linear response at all points R²=0.99. The reconstructed pressure point is close to the actual pressure point (highlighted by a dashed line in the inset image). At a certain point on the sensing skin, sensitivity is affected by three parameters: arc ratio, current path, and piezoresistive channel. Areas closer to electrodes C/Cₘₐₓ>0.6 have a higher sensitivity. The sensitivity range is around 0.1 kPa⁻¹ for the range 0.1<C/Cₘₐₓ<0.5. The second factor is whether the point lies on a current path. Because adjacent current injection was considered in the example experiments, the points located on the NE show higher sensitivity around 11.4% on average, compared to the points on E. For the arc ratios of

$$C / {C}_{m ax} = \frac{1}{7} , \frac{2}{7} , \frac{3}{7} , \frac{4}{7}$$

on NE show 18%, 7%, 25%, and 23% higher sensitivity compared to their corresponding distance but on E. Another reason is whether the point is located on a piezoresistive channel. At the arc ratio of

$$C / {C}_{ma x} = \frac{2}{7} ,$$

the difference between the NE and E is less than the other, because of locating on a piezoresistive channel. Moreover, at

$$C / {C}_{m ax} = \frac{5}{7}$$

the point located at E has 16% higher sensitivity than the point on NE (unlike other points) because of locating on 5 piezoresistive channels.

In the example experiments, cyclic loadings were carried out on the sensing skin to see the repeatability and hysteresis performance of the sensing skin (shown in FIG. 27). Hysteresis measurements in the sensing skin revealed an average drift of 4.85% at 50 kPa during loading and unloading at the point C/Cₘₐₓ= 2/7 (shown in FIG. 27). The drift error was measured at kPa for cycles 50, 75, 125, and 150 as 6.1%, 2.4%, 2.6%, and 5.4%, respectively, which is consistent regardless of cycle number. The results are thus linear and consistent. FIG. 27 illustrates the sensor's response at

$$C / {C}_{m ax} = \frac{1}{7} ,$$

which was highly repeatable for 150 cycles of loading to 110 kPa.

To test the performance of the sensor 50, two different measures were defined: position error and tactile area detection (TAD) ratio. The TAD ratio is the actual loaded area over the area of the reconstructed image corresponding to at least 75% of the maximum applied pressure and is used to determine the sensor's ability to distinguish between two simultaneous stimuli applied on overlapping areas. The average TAD ratio was measured on these points through loading at 10-100 kPa (as shown in FIG. 28A), and was found to vary between 80-100% at different points. For all points except C/Cₘₐₓ≤ 1/7, it shows a value close to 100%, indicating that the proposed sensor can detect the actual pressure area.

Position error is defined as the difference between a pressure point's actual radius and the reconstructed radius over the actual radius for measuring sensing skin reconstruction accuracy (as shown in FIG. 28B). As with the sensitivity distribution, results show that the E has slightly higher position errors yet is close to the NE due to being located on longer current paths. Moreover, the position error is decreasing from the center to the middle of the sensing skin (C/Cₘₐₓ= 3/7), then it is increasing to the boundary. There is a trade-off between the arc ratio and the chance of being on a piezoresistive channel (piezoresistive channel density). There is a greater chance of being on a piezoresistive channel in the center of the sensing skin than on the border (which can reduce the position error). In spite of this, the center tends to have a higher position error since it is further away from the electrodes. As a result, the error is minimum at the middle arc ratio (C/Cₘₐₓ= 3/7) of the sensing skin and increases toward the border or center as it approaches. Approaching the center causes the position error to increase more rapidly than approaching the boundary. The effect of distance from the boundary is therefore greater than that of piezoresistive channel density.

FIG. 28A is a chart showing TAD ratios and FIG. 28B is a chart showing position error for different arc ratios (C/Cₘₐₓ), and whether the measured point is located on an electrode (E) or not (NE).

The example experiments investigated the effect of applied pressure angle on sensing skin performance since oblique pressure may impact sensing sensitivity. The pressure was applied with a sphere tip (diameter of 1 cm) to ensure consistency. To calculate the sensor's sensitivity, different loading values (3, 5, and 7 N) at three angles (60°, 90°, and 120°) were applied to the sensing skin at C/Cₘₐₓ=3.5/7 (shown in FIG. 29A). The sensitivity results are presented in FIG. 29B. The sensitivity values were consistent for all angles, with slightly higher sensitivity (around 3%) at 60° compared to 90°, and 120°. This can be attributed to the force direction, which is pointed towards the center at 60°, resulting in less space to expand and higher sensitivity. In contrast, pressing the sensor outward (such as at 120°) allows for more expansion, resulting in lower sensitivity. The consistent sensitivity values for all points indicate that the angle of applied pressure does not significantly impact the sensor's performance.

The example experiments also investigated the performance of the sensor 50 in double and triple touch sensing. Double and triple touch experiments were conducted using different configurations, as shown in FIGS. 30A to 30D; where each touch point was pressed with a hand. The reconstructed pressure distributions were consistent with the applied pressure configurations and were better as the pressure points were farther apart. The results illustrated that the system 100 performed well in multi-point touch sensing upon various pressure applications. Particularly, in contrast to other approaches, the system 100 was able to accurately determine multi-touch pressure points where at least one of the pressure points was closer to the centre of the sensor and away from the boundary; due to the enhanced sensitivity of the sensor 50 in the middle region of the sensor 50.

FIG. 30A illustrates the results from two points spaced 3 cm apart in the middle. FIG. 30B illustrates the results from two points spaced 5.5 cm apart with one in middle and the other close to the boundary. FIG. 30C illustrates the results from three points, with two of them 2.5 cm apart in the middle and one other one close to the boundary. FIG. 30D illustrates the results from three points, each 5.25 cm apart from the other and close to the boundary.

While the example experiments considered a 3D concave symmetric lattice pattern, it is understood that any suitable lattice pattern and 3D shape can be used; particularly where the pattern is tailored for customized sensitivity distribution and spatial resolution.

As illustrated in the example experiments, the sensor 50 can be in the form of a large 3D convex surface. This makes the sensor 50 suitable for a number of applications; for example, for use as a robotic skin, haptic feedback system for virtual reality and augmented reality applications, prosthetics, and assistive devices. The lattice structure, with conductive paths, of the sensor 50 provides higher sensitivity and spatial resolution compared to a uniform structure. For the example experiments, an interconnected lattice pattern was used, which follows the equipotential lines after current injection (increased sensitivity) and can cover the entire surface (high spatial resolution). Additionally, advantageously the sensor 50 offers a linear response at all points R²=0.99. Additionally, the average tactile area detection (TAD) ratio was measured as 96% on different points through loading at 10-100 kPa. The sensitivity values of the sensor 50 were shown to be consistent and similar across all angles. Additionally, the sensor 50 performed well in double and triple-touch experiments. Accordingly, the sensor 50 provides a relatively high sensitivity and spatial resolution for various sensing applications, for both 2D and 3D shapes.

In view of the embodiments described herein, the lattice arrangement of conductive materials on a nonconductive substrate is particularly advantageous. The lattice pattern used can depend on a number of suitable factors; for example, on a geometry of the sensor (i.e., the sensor boundary shape), on a desired spatial sensitivity, and on a desired spatial resolution. Lattice structures, for example, four-fold symmetry and six-fold symmetry patterns, can be used for polygonal sensor geometries; for example, for triangles, squares, rectangles, and hexagons. The selected lattice patterns need not necessarily have similar sizes throughout the sensor. The size of the gaps and the lattice channel thickness can vary. In an example, the present inventors have determined that a variable size four-fold symmetry pattern provides an optimum structure for a square shape sensor. In another example, the present inventors have determined that an interconnected lattice pattern provides an optimum structure for a circular geometry, with high sensitivity and spatial resolution.

The embodiments described herein also illustrates that, advantageously, the sensor 50 can be used to make pressure measurements having either a 2D or 3D surface. While in other approaches, pressure measurements are only possible where there is conductive material at the location of the pressure application, the sensor of the present embodiments advantageously allows for interpolating pressure measurements even at points between conductive material.

For measurements on a convex 3D surface, the system 100 can utilize EIT and map it to a 2D configuration. To map and sense in 3D geometries, the system 100 determines a boundary shape and relates a perimeter length of the pressure point on the sensing skin to a length of a reconstructed image. In the case of a paraboloid shape, the arc ratio on the actual sensor can be determined to be equivalent to a radius on the reconstructed image.

In further cases, deep learning techniques can be used to improve image reconstruction and enhance resolution. In some cases, EIT approaches can struggle with issues such as noise and ill-posedness, leading to lower-quality images. Deep learning models, like convolutional neural networks (CNNs), can learn from large datasets to predict impedance distributions more accurately. This approach can help significantly reduce artifacts and improve the clarity and reliability of EIT images. Thus, CNN-based EIT can be used to augment the calibration approach described herein.

Although the invention has been described with reference to certain specific embodiments, various modifications thereof will be apparent to those skilled in the art without departing from the spirit and scope of the invention as outlined in the claims appended hereto.

1. A pressure sensor for converting applied pressure to electrical signals, the pressure sensor comprising:
a non-conductive substrate;
conductive material in the non-conductive substrate, the conductive material forming a lattice structure; and
a plurality of electrodes connected to the conductive material at respective locations of a boundary of the lattice structure.

2. The pressure sensor of claim 1, wherein the conductive material comprises a polymeric or cementitious composite.

3. The pressure sensor of claim 2, wherein the composite comprises a combination of carbon black and silicone.

4. The pressure sensor of claim 1, wherein the conductive material is configured into a plurality of channels that are connected to each other to form nodes, the respective location of each of the electrodes is at a respective one of the nodes.

5. The pressure sensor of claim 1, further comprising a non-conductive substrate, wherein the conductive material is located inside the non-conductive substrate.

6. The pressure sensor of claim 1, wherein the non-conductive substrate comprises a silicone rubber.

7. A method of using a pressure sensor, the pressure sensor comprising a non-conductive substrate, a conductive material in the non-conductive substrate that forms a lattice structure, and a plurality of electrodes connected to the conductive material, the method comprising:
selecting a pair of electrodes;
iteratively performing:
directing current to the selected pair of electrodes;
receiving voltage measurements across non-selected electrodes;
determining whether each pair of electrodes has been selected, and where each pair of electrodes has not been selected, selecting a previously not selected pair of electrodes and performing a further iteration, otherwise performing no further iterations;
determining resistivity and/or conductivity at each node in the lattice structure using the voltage measurements;
correlating the resistivity and/or conductivity value at each node to a pressure value using a calibrated transfer function; and
outputting the pressure values.

8. The method of claim 7, wherein determining the resistivity and/or conductivity at each node in the lattice structure comprises using an inverse Maxwell equation.

9. The method of claim 8, wherein the inverse Maxwell equation is solved considering an inverse of a Jacobian matrix to determine conductivity or resistivity changes based on known differential voltage measurements across a boundary of the lattice structure.

10. The method of claim 9, wherein temporal changes in conductivity or resistivity are determined by evaluating instant potential measurements and homogeneous baseline potential measurements at two different times and the difference is determined using the Jacobian matrix.

11. The method of claim 7, wherein directing current to the selected pair of electrodes comprises injecting a constant current into the pair of electrodes.

12. The method of claim 7, wherein directing current to the selected pair of electrodes comprises using a constant voltage source to inject current into the pair of electrodes.

13. The method of claim 12, further comprising using a voltage divider resistor to measure the current injected into the pair of electrodes.

14. The method of claim 7, wherein the selected pair of electrodes are adjacent electrodes.

15. The method of claim 7, wherein directing current to the selected pair of electrodes comprises using a direct-current source.

16. The method of claim 7, wherein directing current to the selected pair of electrodes comprises using an alternating-current source, and wherein the resistivity and/or conductivity values comprise admittance and/or impedance values.

17. A method of calibrating a pressure sensor, the pressure sensor comprising a non-conductive substrate, a conductive material in the non-conductive substrate that forms a lattice structure, and a plurality of electrodes connected to the conductive material, the method comprising:
iteratively performing for a predetermined number of iterations:
applying a selected pressure to the sensor, the selected pressure having not previously been selected;
selecting a pair of electrodes;
iteratively performing while the selected pressure is applied to the pressure sensor:
directing current to the selected pair of electrodes;
receiving voltage measurements across non-selected electrodes;
determining whether each pair of electrodes has been selected, and where each pair of electrodes has not been selected, selecting a previously not selected pair of electrodes and performing a further iteration, otherwise performing no further iterations;
determining resistivity and/or conductivity at each node in the lattice structure using the voltage measurements;
correlating the resistivity and/or conductivity value at each node to the known pressure value;
determining a transfer function correlating change in resistivity and/or conductivity to pressure based on the relationship between the change in resistivity and/or conductivity and the applied pressure; and
outputting the transfer function.

18. The method of claim 17, wherein determining the transfer function correlating change in resistivity and/or conductivity to pressure based on the relationship between the change in resistivity and/or conductivity and the applied pressure comprises using Tikhonov regularization and Gauss-Newton reconstruction to determine reconstructed changes in relative resistance at different pressure values and at different points over the lattice to derive the transfer function.

19. The method of claim 18, wherein the lattice structure is conceptually divided into a finite number of elements for Tikhonov's regularization and Gauss-Newton reconstruction.

20. The method of claim 18, further comprising using a deep learning model to predict resistivity and/or conductivity during calibration.
